(19) United States
(12) Patent Application Publication
(10) Pub. No.: US 2002/0010665 A1
(43) Pub. Date: Jan. 24, 2002

(54) Real time global tariff and import data system and method

(76) Inventors: Guy V. Lefebvre, Outremont (CA); Michel Lapointe, Ste-Catherine (CA)

Correspondence Address: David M. Mello, McDermott, Will & Emery, 28 State Street, Boston, MA, 02109, US

(21) Appl. No.: 09/867,206

(22) Filed: May 29, 2001

Related U.S. Application Data
(60) Provisional application No. 60/207,788, filed on May 30, 2000.
(60) Provisional application No. 60/232,088, filed on Sep. 12, 2000.
(60) Provisional application No. 60/250,407, filed on Nov. 30, 2000.
(60) Provisional application No. 60/279,641, filed on Mar. 29, 2001.

(51) Int. Cl. G06F 17/60

(52) U.S. Cl. 705/31

(57) ABSTRACT

The present invention is a system and method for providing real-time tariff and import data over a computer network, including, preferably, the calculation of total landed cost. The total landed cost is calculated as a function of input transaction information, such as transaction value, freight and insurance costs, type of good(s), import, shipment, and export countries. A duty calculation engine accesses relevant tariff rates and applies the lowest of such rates to arrive at a duty calculation. An import tax calculation engine accesses relevant databases of country specific import tax rates, charges and fees and applies them to arrive at import tax costs. A total landed cost calculation engine determines the total landed cost from the duty calculation and the import tax calculation.

### CROSS REFERENCE TO RELATED APPLICATIONS

This application claims the benefit of priority from commonly owned U.S. Provisional Patent Application Ser. No. 60/207,788, filed May 30, 2000, entitled SYSTEM FOR PROVIDING CONTINUOUSLY UPDATED REAL TIME GLOBAL CUSTOMS, TARIFF AND IMPORT DATA VIA A COMPUTER NETWORK; U.S. Provisional Patent Application Ser. No. 60/232,088, filed Sep. 12, 2000, entitled GLOBAL PRODUCT IDENTIFICATION SYSTEM FOR DETERMINATION OF TARIFFS; U.S. Provisional Patent Application Ser. No. 60/250,407, filed Nov. 30, 2000, entitled MASTER UNIVERSAL TARIFF SOFTWARE; and U.S. Provisional Patent Application Ser. No. 60/279,641, filed Mar. 29, 2001, entitled MASTER UNIVERSAL TARIFF SYSTEM AND METHOD, incorporated herein by reference.

### FIELD OF THE INVENTION

The present invention generally relates to systems and methods for providing tariff and import data. More specifically, the present invention relates to computer systems that determine and make such data available over a network.

### BACKGROUND OF THE INVENTION

Over the past several years there has been a simultaneous growth in international trade and global interaction and expansion of the World Wide Web (“the Web”). Increasingly, nations and regions are entering into trade agreements to facilitate increased international trade. World markets are becoming more interrelated and the demands for the importation of goods and services is growing accordingly. Part of the increased demand may also be attributed to the growth of the Web. The Web allows consumers, whether businesses, organizations, or private individuals, to shop the world on-line, from the convenience of a home or office computer.

Unfortunately, despite increased activity and demand, issues surrounding international transactions remain. That is, for each purchase of a product from another country, certain tariffs (or duty) and import taxes are usually applied to the transaction. Tariff rates and tax rates are country specific and change from time to time. Additionally, for each country, duty rates and tax rates tend to vary among types or categories of products, thus multiplying the complexity and volume of duty and tax information.

Keeping track of such a large volume of information can be a daunting and expensive undertaking for a seller (e.g., retailer or distributor). As a result, fulfillment of international orders emanating from customers located around the globe is attempted by only a small percentage of companies, due to the complexities of shipping across international borders. Of that small percentage that does attempt fulfillment of international orders, most usually only ship to a handful of countries.

To enable businesses, organizations, and individuals to more readily conduct international transactions, there is a need for a comprehensive system that provides updated tariff and tax information, as well as other transaction related costs and information. There is a further need for such a system to be a real-time system and for it to be accessible and functional over the Web, or other networks.

### SUMMARY OF THE INVENTION

The present invention is a system and method for providing real-time tariff and import data over a computer network, preferably including the calculation of total landed cost. A duty calculation engine accesses relevant tariff rates and applies the rate that is applicable to arrive at a duty calculation. An import tax calculation engine accesses relevant databases of country specific import tax rates, charges and fees and applies them to arrive at import tax costs. A total landed cost calculation engine calculates a total landed cost from the calculated duty (or tariff) and import tax, along with other transaction related costs, such as freight and insurance costs.

A real-time tariff and import data system in accordance with the present invention, may be implemented as a business-to-business (“B2B”) system, a business-to-consumer (“B2C”) system, or as some combination thereof. The system may be accessed over one or more of any of a variety of networks, such as local area networks (LANs), wide area networks (WANs), virtual private networks (VPNs), intranets, extranets, the World Wide Web (the “Web”), the Internet, telephone networks or some combination thereof.

The real-time tariff and import data system includes databases having current duty and tax rate information for a plurality of countries. These databases are coupled to a set of servers, for example, which host the duty calculation, tax calculation, and total landed cost calculation engines. The servers are accessible by any of a number of types of network enabled devices, such as personal computers (PCs), workstations, other (third party) servers or systems, personal digital assistants (PDAs), telephones, or other such devices. The data in the databases may be automatically updated by remote third party sources or they may be updated locally, or some combination thereof. Also, rather than representing each country in the system databases, the real-time tariff and import data system servers may link to third party sources of such tariff and tax information. The databases are kept substantially current, to provide accurate information to customers.

The content of the databases may embody trade restrictions imposed between countries. That is, where a country prohibits trade with another country, the real-time tariff and import data system may include a transaction validity checker that alerts the customer that the input transaction is forbidden by one of the countries (e.g., destination country) involved. For example, the United States prohibits the importation of cigars from Cuba. If a customer entered information for such a transaction, the real-time tariff and import data system may be configured to alert the customer to the trade restriction or may refuse to perform the requested calculations.

Users enter transaction inputs via an electronic device (e.g., PC, workstation, PDA, and/or other network enabled devices configured for user input). The inputs may include one or more of a PIN (if access is controlled), access code, origin country, shipment (or export) country, destination (or import) country, input code type, product code, transaction value, number of units being bought, unit code, cost of transportation, insurance cost, other (ancillary) costs, transaction currency, conversion currency, and output format code.

The access code input specifies whether the duties and taxes are calculated within or over a volume quota for a given product in a given country. The origin country is the country from where the product is considered to be manufactured. The shipment country is the country from where the products are sent. And, the destination country is the country to where the products are to be sent, also referred to as the country of importation. The input code type represents the type of input given for the product code (e.g., HS code or user defined product code). The product code identifies the category of the product. The unit code specifies the units (e.g., pounds, liters and so on) associated with the products, and the number of units tells how many units are being imported (e.g., 10, 000). A desired output format from a predetermined set of output formats can be specified by the user through entry of an output format code. Output formats include duty rate, duty amount, detailed duty, tax rate, tax amounts, detailed taxes, duty and tax rates, duty and tax amounts, detailed duty and tax output, or total landed cost.

The inputs are entered into an on-line request form, which may be an XML (extensible Markup Language) document, for example. Preferably, the present invention includes a Web-based interface that allows users to interact with the system and get duty tariff and import data system servers to produce an output, in accordance with the chosen output format. As a Web accessible system, the real-time tariff and import data system is configured to provide real-time import duty, tax, and total landed cost information for shipments among the various countries represented in the databases.

In the present invention, the real-time tariff and import data system may be accessed by any of a variety of client device configurations, such as Web user client, a Java client 102B, and an XML client. Regardless of the configurations of the client device, communication between the client device and the real-time tariff and import data system is preferably accomplished using standard communication and format protocols and languages, such as the Internet Protocol and XML. Additionally, communication using encryption and access control mechanisms may be used.

In various embodiments, the present invention may include functionality or links to insurance providers for obtaining insurance cost figures and/or to transportation providers for obtaining transportation figures. Additionally, the present invention may also facilitate or enable the purchasing of such insurance and transportation. In such embodiments, the user need not input insurance or transportation cost information, as the case may be, and the outputs may variously include the system calculated insurance and transportation costs.

The real-time tariff and import data system may provide for customer account and billing, based on use, transactions, or flat fee structures. The system may serve as a back-end system for a third party, or as a front end system that is directly accessible by customers.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is a representative architecture of the real-time tariff and import data system, in accordance with the present invention;

FIG. 2 is an architecture of a distributed real-time tariff and import data system, in accordance with the present invention;

FIG. 3 is a software architecture for the real-time tariff and import data system of FIG. 1 or FIG. 2;

FIG. 4 is a block diagram showing the primary functional components of the software architecture of FIG. 3;

FIG. 5 is a diagram depicting a standard Web browser-based approach to client-server exchange with the real-time tariff and import data system of FIG. 1 and FIG. 2;

FIG. 6 is a diagram depicting a Java-based approach to client-server exchange with the real-time tariff and import data system of FIG. 1 and FIG. 2;

FIGS. 7A, 7B and 7C are diagrams depicting XML request string exchange and processing by the real-time tariff and import data system of FIG. 1 and FIG. 2;

FIGS. 8A, 8B and 8C are diagrams depicting Web-based request exchange and processing by the real-time tariff and import data system of FIG. 1 and FIG. 2; and

FIGS. 9A and 9B are diagrams depicting Java-based request exchange and processing by the real-time tariff and import data system of FIG. 1 and FIG. 2

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

The present invention is a system and method for providing real-time tariff and import data over a computer network, including the calculation of total landed cost. In the preferred form, a duty calculation engine accesses relevant tariff rates and applies the rate that is applicable to arrive at a duty calculation. An import tax calculation engine accesses relevant databases of country specific import tax rates, charges and fees and applies them to arrive at import tax costs. A total landed cost calculation engine determines the total landed cost from the duty calculation and the import tax calculation, along with other transaction related costs, such as transaction value, freight and insurance costs, type of good(s), import, shipment, and export countries.

A real-time tariff and import data system in accordance with the present invention, may be implemented as a business-to-business (“B2B”) system, a business-to-consumer (B2C) system, or as some combination thereof. The system may be accessed over one or more of any of a variety of networks, such as local area networks (LANs), wide area networks (WANs), virtual private networks (VPNs), intranets, extranets, the World Wide Web (the “Web”), the Internet, telephone network, or some combination thereof. The real-time tariff and import data system may serve as a front-end system, directly accessible by those seeking tariff, import tax and/or total landed cost data for a transaction. In other embodiments, the real-time tariff and import data system may serve as a back-end system, coupled to a front-end international transaction system, for example.

Part I—Hardware And Software Architecture

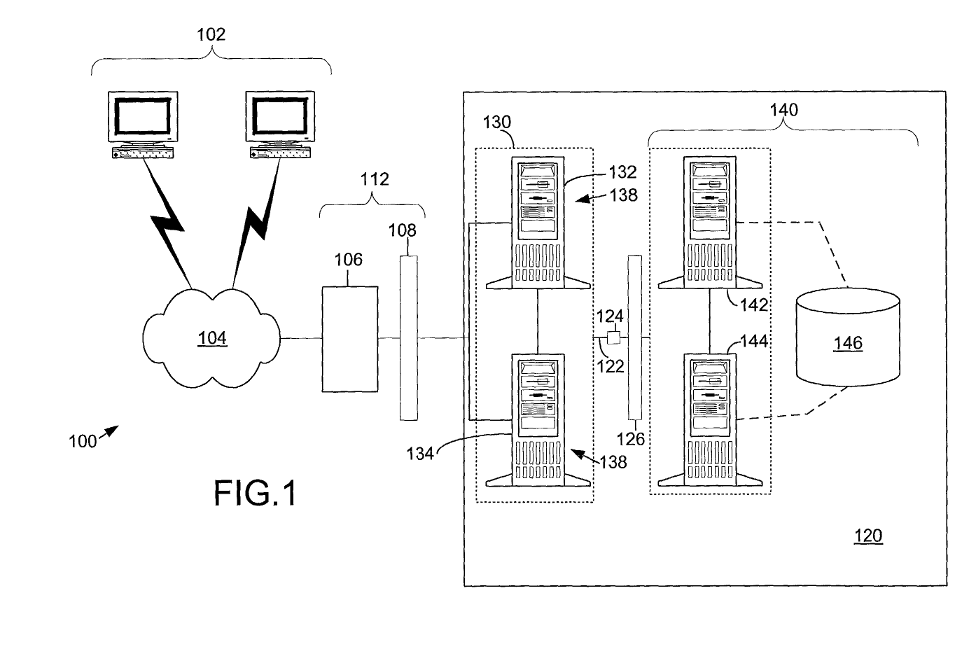

FIG. 1 shows a representative architecture 100 implementing the present invention. Architecture 100 includes a set of client devices 102 configured to access the real-time tariff and import data system 120 via the Internet 104. Access to the real-time tariff and import data system may be provided via a standard router 106 and firewall 108.

In accordance with the preferred embodiment, the real-time tariff and import data system 120 makes information accessible regarding tariffs in approximately 225 countries for approximately 5,800 products listed in the Harmonized Coding System (HCS), which are represented as established country-based product Harmonized System (HS) codes. Along with information on various customs duties, applicable tax rate information is provided for a plurality of products, and vital information necessary or useful for doing business in various countries. Such information is stored and managed by a database management system 140.

Preferably, the real-time tariff and import data system 120 includes the following characteristics:

(1) High Level of Availability: To simultaneously accommodate the needs of clients around the globe, the system is preferably accessible for substantially 24 hours a day, 7 days a week, for a total availability rate of approximately 99%, or more. To accomplish such high availability, the system architecture accommodates a minimal mean-time-to-recovery (i.e., not more than a few seconds), which may be accomplished, at least in part, with customary redundancy, “hot spares”, and fail-over mechanisms. As examples, for a 99% availability rate, the system can not be down for more than 88 hours per year (i.e., up for 8,672), and for an availability rate of 100% the system is down for 0 hours per year (i.e., up for 8,760).

(2) High Level of Transparency of System Faults: Owing to the recovery mentioned above, client-users are substantially unable to detect that a system fault has occurred. In a worst-case scenario, response time of the system is only prolonged by a few seconds, rather than producing error messages or terminating jobs.

(3) Ability to Cope with a High Volume of Transactions: User traffic is an important factor to take into consideration with regard to bandwith use. Indeed, the width of the bandwith is an important element in the system response time. The following table, Table 1, presents the number of concurrent users that can be supported, depending on the kind of bandwith used (calculated for a connection lasting in the order of 15 seconds):

TABLE 1
Concurrent Users

| Connection | | Concurrent | |
|---|---|---|---|
| type | Maximum bandwidth* | users* | Hits per day* |
| Dedicated | Modem Speed | 6 | 46,258,560 |
| PPP/SLIP | | | |
| 56K | 56,000 bps | 9 | 70,383,909 |
| (Frame Relay) | | | |
| ISDN | 56,000-64,000 bps | 19 | 157,988,571 |
| (using PPP) | | | |
| T1 | 1,540,000 bps | 210 | 1,851,428,571 |
| Fractional T1 | Varies as needed | Varies | Varies |
| T3 | 45,000,000 bps | 6,277 | 55,525,083,429 |
| OC3 | 150,000,000,000 bps | 20,927 | 185,142,857,143 |

*These values are estimates and may vary, but they are useful as guidelines in choosing connection types.

(4) Tamper-Proof Data and Transaction Security: Use of a variety of security mechanisms, discussed in detail below, provide for control of access to data and protection of databases against attacks via the Internet, and ensures the confidentiality of clients' transactions.

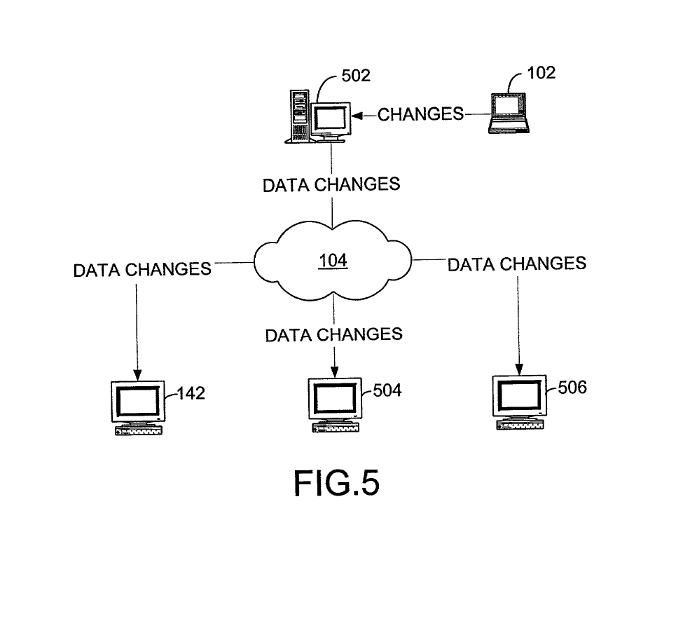

(5) Accuracy of the information contained in databases 146: Customs information varies from country to country. Additionally, countries often pass new laws that change tariffs from one year to the next, or even in the course of the same year. The real-time tariff and import data system 120 allows for the expedient integration of these changes, by accommodating automated information distribution and database updates. Database updates may be accomplished locally, remotely (possibly via third party systems), or some combinations thereof, as discussed in more detail with respect to FIG. 5.

The hardware architecture shown in FIG. 1 embodies the characteristics outlined above. The real-time tariff and import data system architecture 120 includes a cluster of front end application servers 130, as a first logic or application layer, coupled to a back end database management system 140, as a data layer. In the architecture of FIG. 1, the application servers 132 and 134 are accessible via the Internet through a local network 112, which includes router 106 and firewall 108. Firewall 108 protects servers 132 and 134 from Internet attacks by filtering and controlling access to the servers, which is discussed in more detail below.

Generally, one of the major factors in the reliability of a Web site is the reliability of the servers used to host the Web site. Each of application servers 132 and 134 serve as intelligent relief systems to the other; they “know” (i.e., monitor) each other's status, which aids in the processes of load balancing and fault recovery.

While FIG. 1 shows the application layer to include two application servers, a greater number of servers may be used and they may be located at geographically local or remote locations, or some combination thereof The architecture of FIG. 1 offers scalability, in that more servers may be easily added. In the preferred embodiment, an increased number of servers allows increased availability. Additionally, the processing load of the various application object components that are to be executed at a given time on the servers is dynamically balanced among the clustered application servers 130. In the preferred embodiment, the applications running on servers 132 and 134 are written in object oriented code.

Both application servers, 132 and 134, are configured to respond to client requests, so that they can easily share the load. A load-balancing module distributes requests between servers 132 and 134, such modules are known in the art and not discussed in detail herein. If one server (e.g., server 132) is no longer responding, all requests must then be directed towards the other server (e.g., server 134), or other servers if there are more than two application servers. The load-balancing module is replicated on both (or all) application servers, which allows the application servers to ensure continuous request distribution, regardless of which server(s) go down. To ensure system fault tolerance, status information is also replicated on each application server. Thus, even minor faults can be hidden from users, leaving application processing substantially unaffected.

In FIG. 1, the application layer clustered servers 130 are coupled to the data layer 140 via a local network 122 that includes a switch 124 and firewall 126. The database management system 140, or data layer, includes the data servers 142 and 144 and the databases 146 that include all of the tariff and other import data. In the preferred form, database 146 includes a set of shared RAID (Redundant Array of Inexpensive Disks) external disks. RAID systems are known in the art and not discussed in detail herein. In the preferred form, the data layer servers 142 and 144 of FIG. 1 are Microsoft SQL servers, clustered using standard clustering technology (e.g., such as that provided by Microsoft Corporation of Redmond Wash.).

The architecture of the data layer 140 is designed to provide maximum data availability. That is, if one server (e.g. server 142) breaks down, the other server (e.g., server 144) takes over in a manner that maintains transparency to users. Therefore, transactions that are taking place during a database management system 140 fault will not be interrupted, since the requests sent to the faulty server will be automatically transferred to the active server. Since both data layer servers 142 and 144 are connected to RAID external disks 146, disk faults can be dealt with one disk at a time, without halting tasks. Using background monitoring, a problem with one disk can be detected before a fault occurs so that the damaged disk can be replaced before service is interrupted.

Both servers 142 and 144 share a “heartbeat” connection, are part of a local network, are linked to the Internet, and require the use of dual Ethernet network interface cards, in the preferred embodiment of FIG. 1. In this configuration, the database servers 142 and 144 have public IP addresses in order to facilitate data updating operations, but this can expose the servers 142 and 144 to attacks from the Internet. To protect against such attacks, firewall 126 is used to filter requests to the database servers 142 and 144. Thus, only the logical layer servers 132 and 134, i.e., the servers used for updating data (replication), will be able to access the database servers 142 and 144, and server 132 and 134 are also protected by firewall 108.

The databases 146 of database management system 140 includes the following information or databases:

(1) Customs tariff and taxes databases,

(2) Customs information databases on various countries, and

(3) System client databases (where the system maintains client-user accounts).

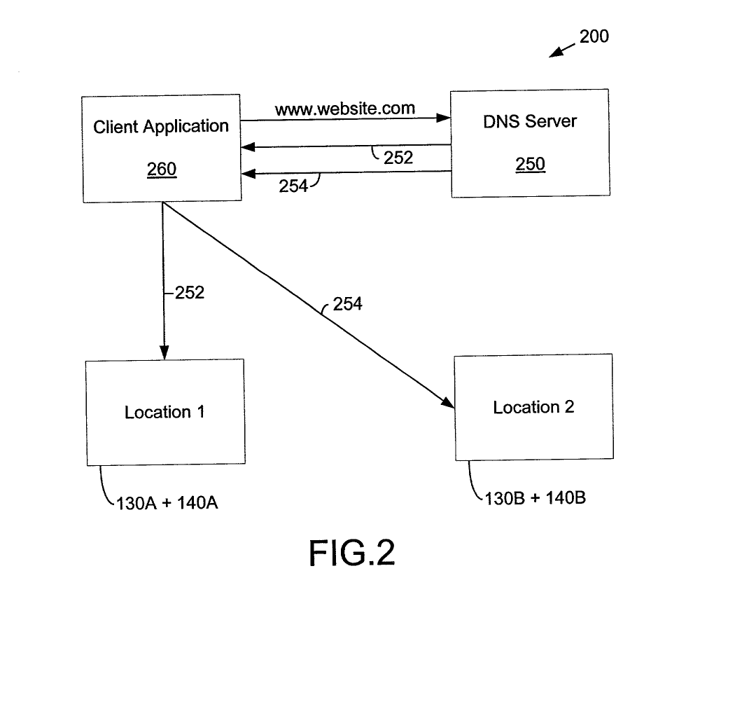

As previously mentioned, real-time tariff and import data system 120 may include multiple application servers in different locations to provide a more robust fail-over solution, in case of major disaster at one site, as is shown in FIG. 2. As previously mentioned, the real-time tariff and import data system 120 is preferably a Web-accessible system. Therefore, a request may be submitted to a Domain Name Server (DNS) 250 which then returns up to two specific IP addresses. Since the real-time tariff and import data system 120 has multiple servers in different locations, in this embodiment, the DNS server 250 returns the optimal address 252 and the second best address 254. The optimal address 252 can be defined as the one with the lowest latency and with an acceptable load.

To provide a fail-over solution and to provide high availability, the client application 260 must react when the response is not sent back after an acceptable timeout. It is preferred that after an acceptable timeout expires, the request is resent a certain number of times to the DNS server 250. To use this feature, a toolkit or client application 260 is configured support the following:

(1) multiple IP addresses in response to it's address resolution request, and

(2) the ability to try to connect using the second IP address, if the first IP address attempt is unsuccessful.

Preferably, the DNS server 250 always returns up to two IP addresses, so if the optimal application server 130A (with DB management system 140A) is down, the client application 260 (or device) redirects the request to the second best application server 130B (with DB management system 140B), after an acceptable timeout as been expired. However, if the client application 260 or toolkit does not support this feature, only the optimal IP address will be available to the client application 260. To have a full fail-over proof client application 260, the timeout is preferably set to be about 10 seconds. Also, when the timeout expires, the client application 260 is configured to re-send the request, alternating from the optimal server 130A to the second best server 130B.

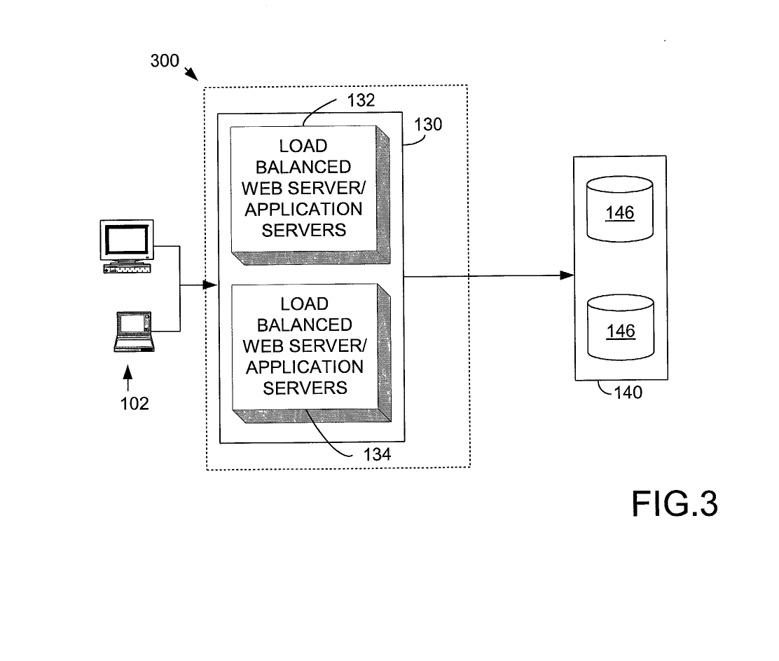

The preferred embodiment of a software architecture 300 of the real-time tariff and import data system 120 is shown in FIG. 3, which serves as the system's logical structure. This logical structure allows for optimal use of resources from different servers. The application servers 132 and 134 support transparent replication, load balancing and fail-over for both the dynamic generation of Web pages (i.e., at the presentation layer) and components (i.e., at the logical layer components).

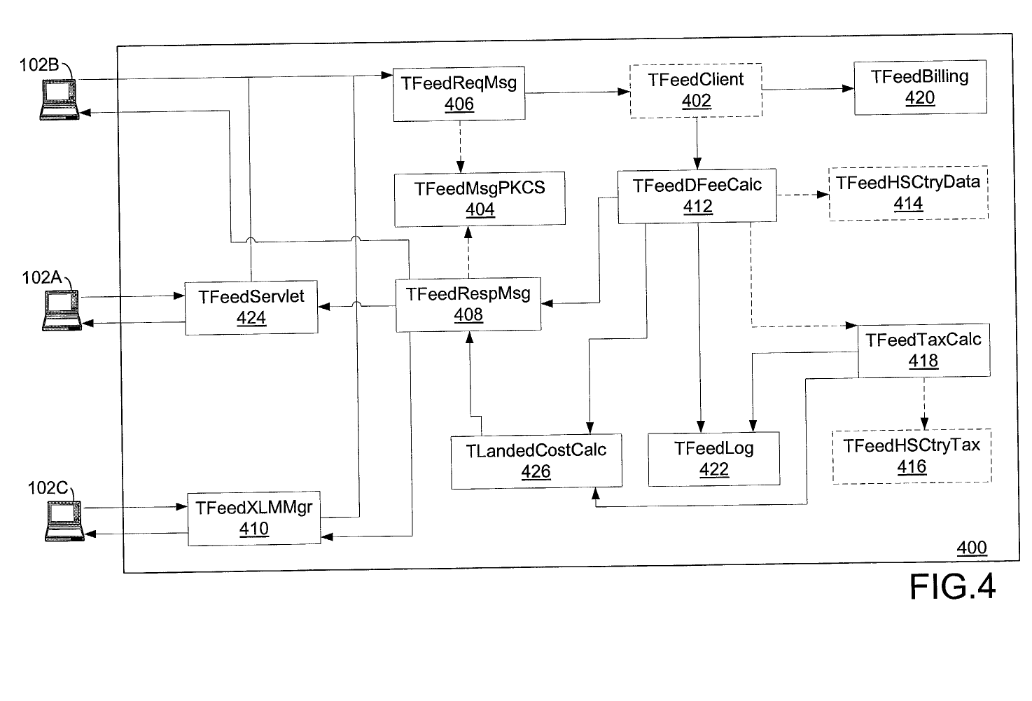

The real-time tariff and import data system 120 main application object components 400 are shown in FIG. 4 and described below.

(1) A TFeedClient object component 402 includes all relevant information for customers (e.g., corporate customers) known to the system and provides methods for accessing specific customer information, which may be stored in customer accounts.

(2) TFeedMsgPKCS object component 404 is configured to customize security levels to client specifications. Data exchanges may be conducted in encrypted or plain-text format. For encrypted transactions, this object component 404 can encrypt and decrypt messages, however, this function requires that public and private access keys be installed in both the customer's system (or client device) and on the application servers 130.

(3) TFeedReqMsg object component 406 prepares received client requests for the other system components. Requests may use the HTTP protocol, may be made directly from the components Java installed in the customer's system or may use an XML format, as described in greater detail below. The TFeedReqMsg object component may be instantiated using any one of these sources.

(4) TFeedRespMsg object component 408 prepares a response to a client request and transmits the response to the client (via TFeed-Servlet, if needed). Responses are directly delivered using HTTP protocol or using an XML format from the TFeedRespMsg object component 406, as described in further detail below with respect to the data exchange process.

(5) TFeedXMLMgr object component 410 manages the exchange of information between the real-time tariff and import data system 120 Web site and clients using an XML format.

(6) TFeedDFeeCalc object component 412 calculates duty fees (i.e., customs charges). This component is also referred to as the duty calculation engine.

(7) TFeedHSCtryData object component 414 provides the tariff for a country and for a specific corresponding HS code. This object component is used by TFeedDFeeCalc 412 to perform customs charges calculations.

(8) TFeedHSCtryTax object component 416 provides the tax rate for a country and for a specific HS code. This object component is used by TFeedTaxCalc 418 below.

(9) TFeedTaxCalc object component 418 applies the tax rate for a product, according to the HS code provided and the country of import, to determine the tax charges This component is also referred to as the import tax calculation engine.

(10) TFeedBilling object component 420 manages the customer account billing process.

(11) TFeedLog object component 422 keeps a running log of all client requests fed into the database. This information may be used as a reference for operating difficulties reported by clients or for cases in which a customer wishes to contest a bill.

(12) TFeedServlet object component 424 manages incoming requests sent via a Web browser and outgoing responses, using HTTP protocol.

(13) TFeedTTLCalc object component 426 calculates the total landed cost for a transaction, using the calculated duty from the duty calculation engine 412 and the import tax calculation engine 418, along with other transaction date (e.g., insurance and transportation costs).

The content of the databases may embody trade restrictions imposed between countries. That is, where a country prohibits trade with another country, the real-time tariff and import data system may include a transaction validity checker (e.g., a TFeedValidTrans component, not shown) that alerts the customer that the input transaction is forbidden by one of the countries (e.g., destination country) involved. For example, the United States prohibits the importation of cigars from Cuba. If a customer entered information for such a transaction, the real-time tariff and import data system may be configured to alert the customer to the trade restriction or may refuse to perform the requested calculations.

In various embodiments, the present invention may include functionality or links to insurance providers for obtaining insurance cost figures and/or to transportation providers for providing transportation figures. Additionally, the present invention may also facilitate or enable the purchasing of such insurance and transportation. In such embodiments, the user need not input insurance or transportation cost information, as the case may be, and the outputs may variously include the system calculated insurance and transportation costs.

Returning to the database management system 140 of FIG. 1, a variety of operations are involved in maintaining data integrity, as discussed below. Database security requires that customer (or user) security measures be established. Therefore, security audits may be conducted on a regular basis to verify access to the database and authentication may be required for access to database 146. SQL Server offers two authentication modes:

(1) Windows NT Authentication Mode: SQL Server can use Windows NT to authenticate users. User accounts are managed and defined in Windows NT and the access rights (and roles) are defined on the SQL Server.

(2) Mixed Mode: Previous modes can be used along with the authentication mode above, which requires that an account be created, with username and password, on the SQL Server. This account is saved in the system tables of the SQL Server.

In the preferred embodiment, the mixed mode is used, since it requires no control over the network and its clients (e.g., NT accounts and client network management). However, users who have different roles may also be defined on the SQL Server. By “role” it is meant that a group of users is treated as a single unit, to which access permissions can be applied. The access permission attributed and/or deleted for one role is applied to all of the users who share that role. The following table, Table 2, shows a list of predefined roles on the SQL Server. New roles may be defined to control access to the tables and/or procedures of any database.

TABLE 2
Predefined Roles

| Fixed database role | Description |
|---|---|
| db_owner | Carries out all of the maintenance and |
| | configuration operations in the database. |
| db_accessadmin | Adds or deletes access rights for Windows NT |
| | users and groups and SQL server accounts. |
| db_datareader | Reads all of the data from all of the tables. |
| db_datawriter | Adds, deletes or modifies the data in all of the |
| | user tables. |
| db_ddladmin | Executes all data definition commands in the |
| | database (i.e., in the Data Definition Library |
| | (DDL)). |
| db_securityadmin | Changes role attribution and manages access |
| | permission. |
| db_backupoperator | Database backup. |
| db_denydatareader | Denies access to functions for reading data in |
| | any of the user tables. |
| db_denydatawriter | Denies access to functions for adding, |
| | changing or deleting data in any one of the user |
| | views or tables. |

SQL Server also has a powerful “Profiler” that records and analyzes all of the operations executed by the SQL Server (i.e., database management servers 142 and 144). The resulting reports can be saved in a text file or in an SQL Server table. Audits regarding access to the servers 142 and 144 may therefore be conducted by recording the following information: access granted; access denied; procedures used; sessions established; and user accounts used. All of this information provides an excellent support tool in establishing who has done what and when.

To protect the databases 146, backup operations are preferably conducted. Generally, there are three methods for performing data backups:

(1) Offline (Cold) Backup: Database services are halted; backup operations are then carried out and the database is put back on line. During this time, the database is not available.

(2) Online (Hot) Backup: Database services are active, the database remains on line, but no access is granted during this operation.

(3) Active Online Backup: The database is active and is accessible by the applications. In the preferred embodiment, option 3 above is used, since it allows backup during normal operations without interruption. This option also allows around-the-clock access. Although this operation minimally increases the server load, it is still advisable to carry out these operations during the hours when the load is at its most stable.

Since there is such a heavy reliance on the database content for producing accurate cost figures, a significant challenge is to guarantee that the information contained in the databases is accurate. One way to ensure the accuracy of data is to perform database updates using the functions of the SQL Server. For example, data replication provides a fast and effective way of distributing information and reducing dependency on a central database server. SQL Server allows users to replicate data from one SQL Server to another SQL Server, or to several other types of databases by different makers (e.g., Oracle, Sybase or IBM DB2). The SQL Server replication function is based on the “publish and subscribe” model in which one database information server plays the role of a “publisher” while the others play the role of “subscribers”, as is shown in FIG. 5. A publisher is the database system or server that makes data available for replication, and may be the “owner” or source of the data. In FIG. 5, database changes may be sent from a client device 102, for example, to a publisher database system 502. Publisher 502 maintains a list of publications (i.e., data for distribution) and subscribers for the publications. A subscriber may be a database server (e.g., servers 142 and 144) that receives and updates (or replicates) its own database data with the updated publication. Subscriber 1 504 and Subscriber 2 506 may be systems, clients, or servers which are not directly a part of the real-time tariff and import data system 120.

Generally, there are two types of subscriptions:

(1) The “pull” subscription, in which the subscriber (e.g., 142, 504, or 506) requests regular updates from publisher 502.

(2) The “push” subscription, in which publisher 502 distributes the changes to various subscribers (e.g., 142, 504 and 506) when changes occur or according to a predefined plan.

Database management system 140 supports at least three types of replication between a publisher and subscribers:

(1) Snapshot Replication: As its name indicates, this type of replication takes a photo or a snapshot of the data to be published at a given moment in time. These snapshots can be taken according to a plan or upon request. Snapshot replication uses very few system resources. However, all of the subscriber data is refreshed. All information is transferred to the subscribers, which requires a high-performance bandwidth for high volumes of data.

(2) Transactional Replication: In this type of replication the changes made at the publisher level are distributed on a continuous basis or at established intervals to one or several subscribers. This type of replication is most appropriate for cases in which only one publisher is available and updates are done on this publisher. Thus, subscribers could upload changes and update their data at a predetermined time.

(3) Merge Replication: This type of replications allows publisher 502 and subscriber 142, 504 and 506 to operate independently of each other and to periodically reconnect to update or consolidate their respective data.

In the case of the real-time tariff and import data system 120 Web site, transactional replication is preferred. Updates on customs data are carried out on a server that plays the role of a publisher and all changes are distributed to subscribers.

The following steps allow implementation of replication functionality on a server that is will play the role of a publisher:

(1) Installation of one version of the database;

(2) Definition of publications and articles (including table sets, information to be replicated);

(3) Configuration of publication mode (for transactional replication);

(4) Definition of a publication frequency (for data transfer to subscribers);

(5) Definition of subscribers (e.g., database servers and in client database servers); and

(6) Configuration of different firewalls or proxies for replication via the Internet.

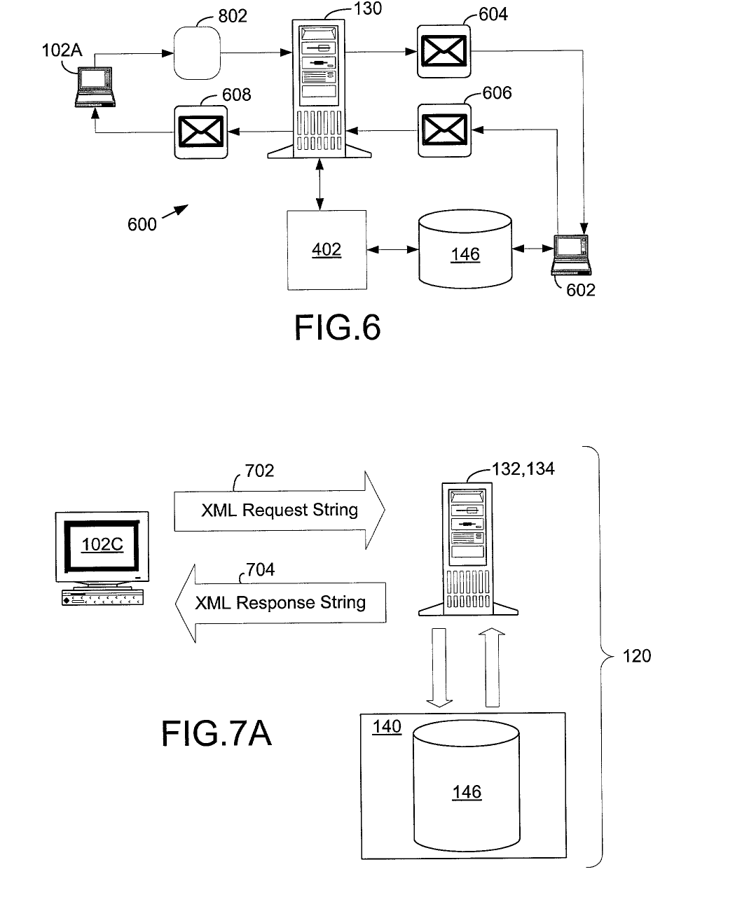

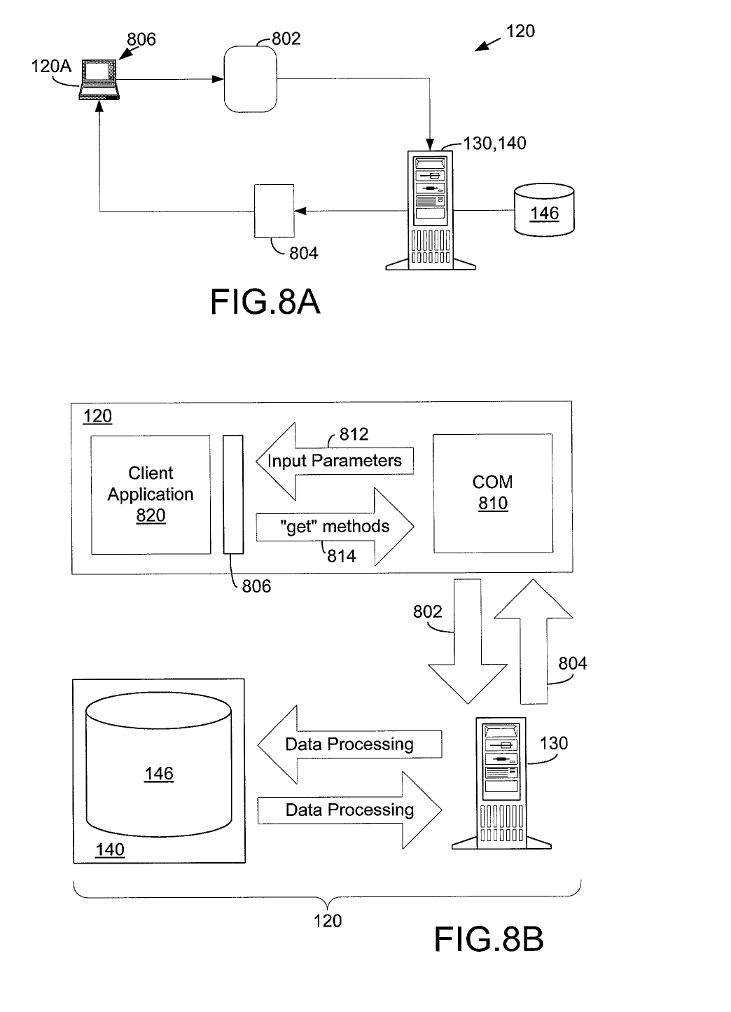

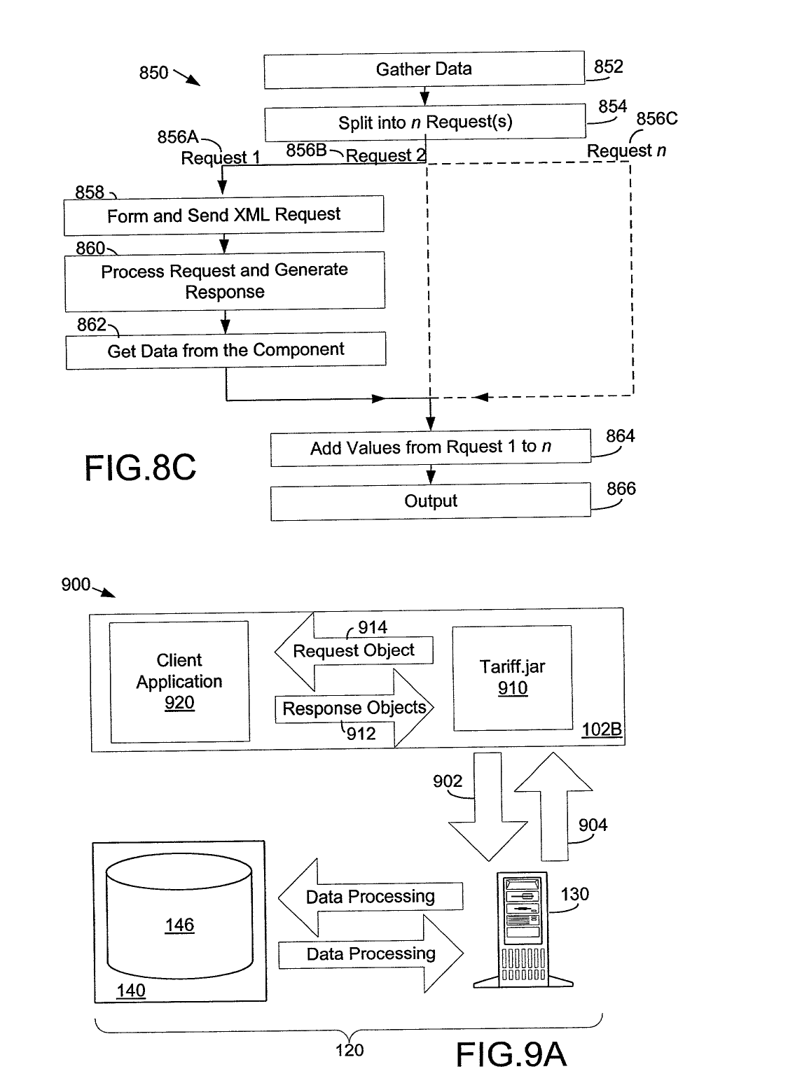

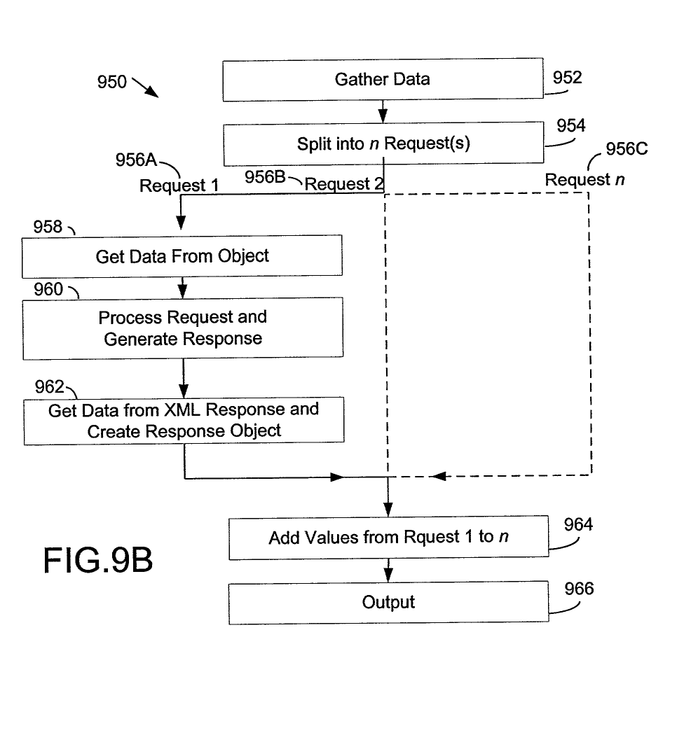

The flow diagram of FIG. 6 illustrates a process 600 used to manage users that access services provided by the real-time tariff and import data system 120. First, a user operating client device 120A that wishes to use the services completes request form 802 (see FIG. 8A), which is made available on the real-time tariff and import data system 120 Web site. The form 802 is sent to the Web server, 132 or 134, and processed by a dynamically generated page using the TFeedClient object 402 (see FIG. 4). Next, a customer manager using device 602 accesses the reformed request 604 and validates the request by verifying the user properly entered required information contained in request form 802 (e.g., username and PIN 606). The application server 130 sends a user authorization 608 to client 102A. Customer manager 602 may open a customer (or user) account using device 602 via, for example, a Web interface. Customer manager 602, preferably, e-mails confirmation to the customer that an account has been opened. Thereafter, the customer can carry out transactions using the real-time tariff and import data system 120 by logging in, without interaction with the customer manager 602. In some cases, installation of client components may be required on the customer's client device, as described with respect to FIGS. 8A-9B.

In some embodiments, the real-time tariff and import data system 120 may be configured to bill its customers for usage, based on, for example, number of Web site hits, transactions processed, or requested outputs. Customer account related information (or billing data) may be stored in databases 146 (or other databases) and a mechanism may be established for customer access of the billing data. There are at least two possibilities in this area:

(1) a Web interface that gives access to a secure environment for billing data, or

(2) a replication of billing data within the real-time tariff and import data system 120, allowing for a connection between a billing database and an accounting system.

The billing data may be use or fee information contained in customer account-related tables. Preferably, the real-time tariff and import data system 120 Web site includes a management section where access to billing data is password restricted, but with proper access allows account access for billing, payment or status.

An activity log is preferably generated to monitor server operations, which may be used for billing, as well as other purposes. Activities logged with respect to server operations may include client related transaction or system performance information (e.g., errors, processor utilization, and so on). That is, a log file may contain information concerning the sources of requests (e.g., IP Addresses, PIN numbers), requested product data, the date of the request and the date and type of information responses sent to clients. This file could be used by network operations or information technology personnel to resolve operations problems. The activity log functionality may also include importing and maintenance information.

A significant part of the real-time tariff and import data system 120 Web site, outside of the database content and user functionality, is its security system. Access is denied to hackers and content is be protected to ensure that it remains precise and consistent. Thus, access to content is controlled, restore mechanisms are implemented, and content integrity is maintained.

The application servers 132 and 134 used in the preferred embodiment provide the best security technology of its kind, with secure, flexible, and easy-to-configure architecture. The application server secures network applications through known, optional encryption, authentication and authorization functions, based on secured SSL RSA sockets, X.509 digital certificates and access control lists (ACLs). Together, all of these security functions allow the system to determine the user of the provided services. Access to some application server 132 or 134 services is controlled through user and user group definition. The term “user” refers to a human (e.g., a customer), a computer application, client device or a remote server. This security technology may be extended to all types of devices and users that access server resources.

ACLs are data structures that control access to resources. Each control list entry contains a set of access permission parameters associated with a user or a user group. Access permission allows the system to carry out certain kinds of operations on server resources. Access permission may be positive (i.e., authorization for certain kinds of operations on specific objects) or negative (i.e., prohibition of some operations on specific objects).

The application servers may be configured for a variety of levels of authentication. In the preferred form, application servers 132 and 134 are configured to use at least one of two processes to authenticate the users: passwords and encryption certificates. For minimal authentication, the process based on the password allows users to provide a password and their user name to access server resources. This process is based on the authentication process defined in the HTTP protocol. A drawback to this process lies in the fact that passwords and usernames are traveling over the Internet in plain text format. For a more comprehensive and powerful authentication system, in the preferred embodiment, encryption is used in the form of encryption certificates. These certificates are issued by a Certificate Authority (CA), such those certificates issued by Verisign, Inc. of Mountain View, Calif.

It is important to ensure that the information that passes through the Internet network circulates in an encrypted channel, and thus cannot be seen or altered. Therefore, application servers 132 and 134 include an SSL implementation used in distributed applications, such as 128-bit SSL Global Server IDs by Verisign. SSL Version 3 allows for connection encryption and is the standard default protocol used to establish private and encrypted communications between two applications within a non-secured network. A digital certificate (or digital ID) is required on the server (e.g., server 132 or 134) for this protocol. A digital certificate allows the server to prove its identity with clients or other servers before a private connection is established. Moreover, for greater security, application servers 132 and 134 can be configured to provide two-way authentication for clients and browsers. In those cases, two-way authentication requires that the client system to have a digital certificate. Digital certificates are then cross-authenticated.

Part II—Preparing and Processing Requests

In order to properly prepare the duty, import tax, or total landed cost of an item, a preferred set of transaction related inputs are required. Preferably, as discussed above, a request is sent from a client (e.g., client device 102) to the real-time tariff and import data system 120 via a Web site interface. In such an embodiment, the real-time tariff and import data system 120 guides the user to enter all needed inputs of the client by providing a well-structured request template or form with syntactic and semantic validation. Table 3 provides the preferred input requirements and their definitions for the request. (See also Appendix H for more information about input validation). The client's request is processed by application servers 132 and 134 of the real-time tariff and import data system 120. After processing, the real-time tariff and import data system 120 returns a response to the client.

TABLE 3
User Inputs

| Parameter | Definition |
|---|---|
| PIN Number | Personal identification number of the client provided by real-time |
| | customs tariffs and import data system 120. |
| Access Code | A code that specifies whether the duties and taxes are calculated within |
| | or over a volume quota for a specific product in a specific country. If |
| | the specific quota is not known by the client, the client choose |
| | “Without” from the Web page request form. (See Appendix F). |
| Origin Country | The country where the product is considered to be manufactured. If |
| | the product(s) are classified by the real-time tariff and import data |
| | system 120, this input is optional since it already resides in database |
| | 146 for each HS code. Otherwise, an origin country code is entered in |
| | the request and the country code in database 146 is not used. See |
| | Appendix A/B for a sample of countries and corresponding country |
| | codes. |
| Shipment Country | The country from where product(s) are sent (i.e., the country of |
| | exportation). See Appendix A/B. |
| Destination Country | The country to where products are sent (i.e., country of importation). |
| | See Appendix A/B. |
| Input Code Type | A code that represents the type of input specified for the Product Code |
| | parameter in the request. See Appendix G. |
| Product Code | Either user defined product code or the established HS code in the |
| | system database. If a user-defined product code is entered, that user |
| | defined product code is used for the entire transaction. If the user uses |
| | an HS code, a valid HS code of the destination country is required. |
| Transaction Value | Value of goods in the currency specified as the transaction currency |
| | parameter. |
| Number of Units | Number of units specified for the Unit Code parameter. |
| Unit Code | If a user-defined product code is entered, a unit code (see Appendix C) |
| | and corresponding unit type (see Appendix D) specified by real-time |
| | tariff and import data system 120 must be entered. If an HS code was |
| | entered, the appropriate unit code and corresponding unit type are |
| | required. The user may be requested to send up to 10 different Unit |
| | Codes and Numbers of Units, in the preferred form. |
| Cost of Transport | The cost of transportation, in the currency specified for the transaction |
| | currency parameter. In some embodiments, this parameter may be |
| | generated upon request by the real-time tariff and import data system |
| | 120 or a third party system coupled thereto. |
| Insurance Cost | The cost of insurance, in the currency specified for the transaction |
| | currency parameter. In some embodiments, this parameter may be |
| | generated upon request by the real-time tariff and import data system |
| | 120 or a third party system coupled thereto. |
| Other Costs | The amount of other costs, in the currency specified for the transaction |
| | currency parameter. |
| Transaction Currency | The currency code used for the amount specified for the transaction |
| | (e.g., U.S. Dollars). See Appendix A/B. |
| Conversion Currency | The currency code used for the results to be provided by real-time |
| | tariff and import data system 120, for any output format under which |
| | dollar amounts are presented. See Appendix A/B. |
| Output Format | Selected by entry of one of the predefined output format codes |
| | provided by real-time tariff and import data system 120. See |
| | Appendix E. |

In the preferred embodiment, a user can obtain the duty, tax and total landed cost associated with an international sale and shipment of one or more products by entering the above inputs. Preferably, the real-time tariff and import data system 120 guides the user to properly enter inputs. When entering the required inputs (previously discussed), the user determines whether to use its own product codes or standard HS codes in the request. If the user uses its own product codes in requests, those product codes can be entered into the system during a classification phase, as part of a user/customer account setup, so that they will be recognized when forming requests. Thereafter, the user can send requests using its own set of codes or the HS codes, either will be valid for the specified unit type. If real-time tariff and import data system 120 also requires a weight unit for the entered product, the request can contain any valid unit code representing a weight: grams, kilograms, pounds, and so on.

The real-time tariff and import data system 120 requires all measurement units to precisely calculate duties and taxes. Even when using HS codes in the request, the user must include all required units. If a unit is omitted, real-time tariff and import data system 120 returns an error message indicating that a unit is missing. For example, certain countries require more than one measurement unit to calculate duties and taxes, or have “multiple units”. For example, assume that a user plans to import wine from the United States to Canada. Canadian authorities calculate duties and taxes depending on the number of wine bottles being imported and the volume of pure alcohol. Therefore, the user needs to send two unit types in the request: a number of wine bottles and pure alcohol volume.

The real-time tariff and import data system 120 provides a default unit code for each unit type known to the system, see Appendix D. When referring to Appendix D, the “Unit Base” column represents the default unit code. All other unit codes from the same unit type have a conversion factor based on the default unit code. Specifying the default unit code in the request typically reduces the response time, since the real-time tariff and import data system 120 will not need to perform a units conversion.

In the preferred embodiment, there are at least three methods for exchanging data between users' (e.g., customers with accounts) client devices and the real-time tariff and import data system 120 Web site. These methods provide users with a large range of request structure possibilities. According to these methods, a client may be a Web user client 102A, a Java client 102B, and/or a client using XML string102C, as examples. Because of its open-ended, flexible and self-descriptive characteristics, the preferred embodiment uses XML technology to exchange information with each type of client device. Thus, an XML format for the information exchanged between the clients and the real-time tariff and import data system 120 Web site is defined. That is, XML is used as a universal data exchange format, regardless of the type of client, as defined below.

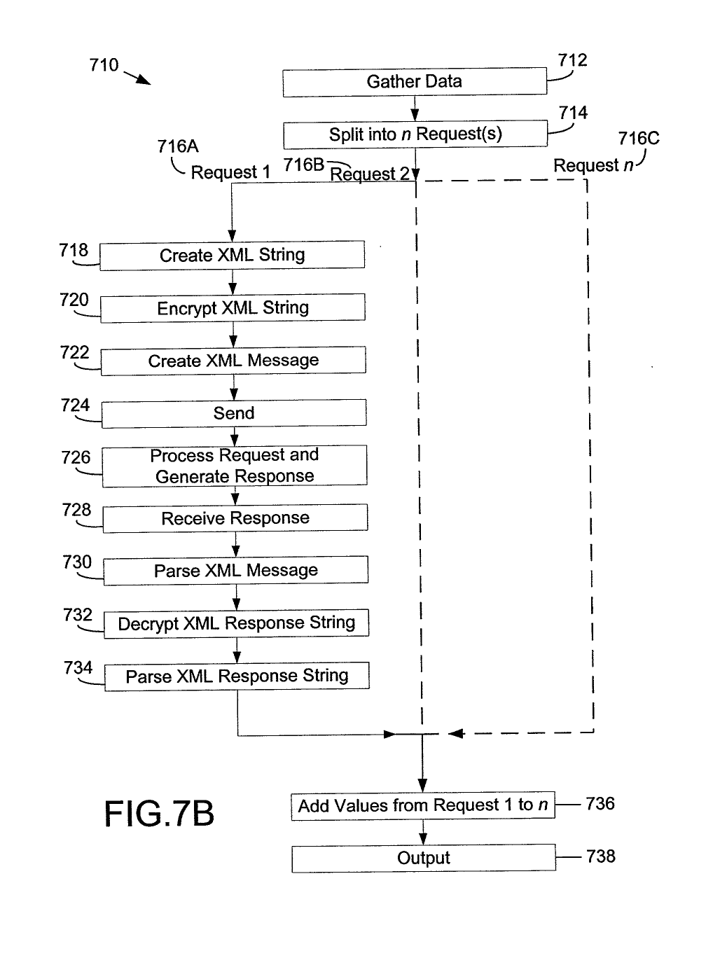

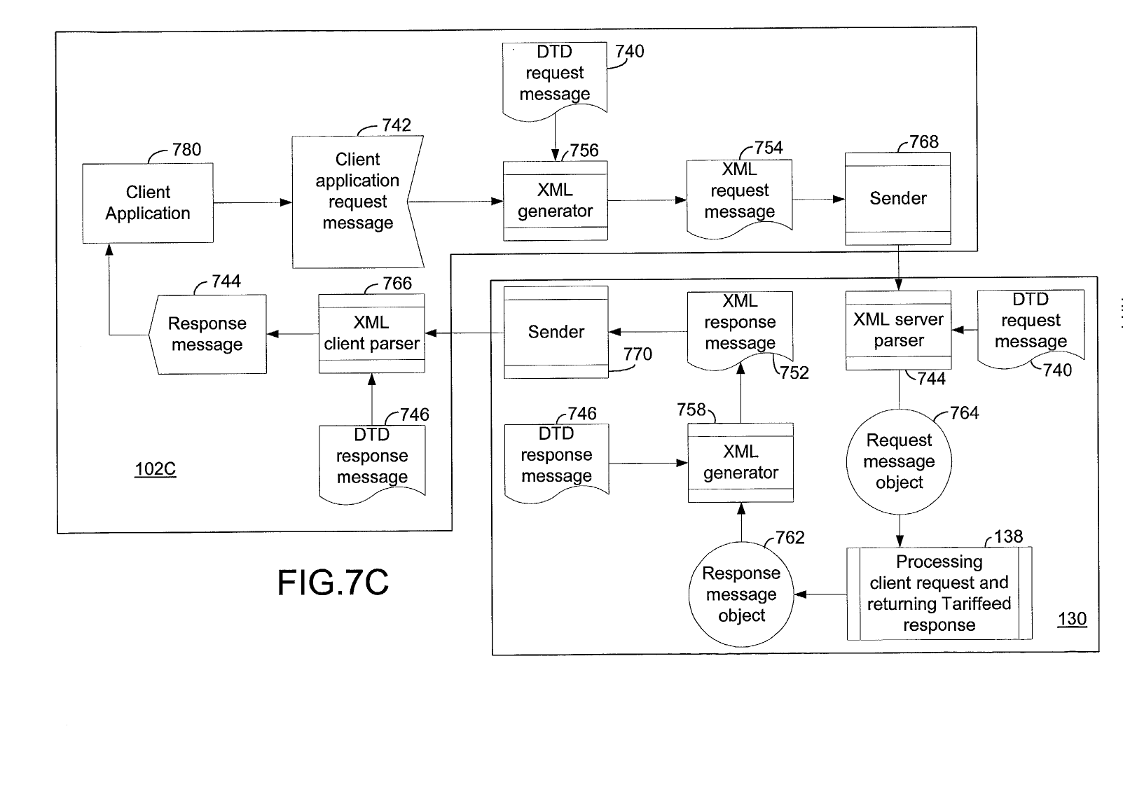

1. XML Clients—To accommodate access by XML clients 102C, the real-time tariff and import data system 120 provides an HTTP service that accepts user inputs as part of a text/XML request from a client, as can be appreciated with respect to FIGS. 7A-C. XML technology is used because it is supported by a variety of programming languages and by Web scripts, such as VBscript or Javascript. XML technology is derived from SGML, a relative of HTML, and defines a syntax for understanding and a format for data processing information. XML syntax includes a series of tags used to insert markers into a document, and is generally known in the art. For example <Product> marks the beginning of the definition of a product and </product> marks the end. A product definition in XML can be written as follows:

<product hscode=“12124560” country=“ca” quantity=“5000”/>

Once analyzed, this XML block will be interpreted as an entity containing three attributes: “hscode,” “country,” and “quantity.” An application can directly retrieve the value of a particular attribute without taking into account the order of the attributes within the document.

Generally, XML technology is open-ended and flexible. For example, an attribute “Price” may be added to a Document Type Definition (DTD) document in order to support the specific needs of a new client application, but the existing client applications would not be affected, since they would continue to search for valid, previously defined attributes. The DTD document is used to validate its corresponding XML documents, thus ensuring that the XML format respects the format specified in the DTD document, so is much less prone to having or causing errors. An XML document can be defined without using a DTD document, but use of a DTD document is preferred. Generally, applications access an XML document using a series of functions defined in a DOM (Document Object Model). A DOM is an XML application that provides a standard programming interface that allows an application to use the information defined within an XML document. FIG. 7A illustrates, at a top level, the interaction between the real-time tariff and import data system 120 and XML client 102C. An XML request message including an XML request string 702 is sent to and processed by server cluster 130 (including servers 132 and 134). Server cluster 130 returns an XML response message including an XML response string 704, as discussed in further detail below.

The communication between client device 102C and real-time tariff and import data system 120 is shown in flowchart 710 of FIG. 7B. FIG. 7C shows a detailed view of the components involved in carrying out the steps of flowchart 710. In step 712, a client application 780 of client 102C gathers user input data to generate one or more client application request messages 742. In step 714 of FIG. 7C, using the data, the client application 780 generates a plurality of requests, i.e., Request 1 716A, Request 2 716B, and Request n 716C. When possible, generating multiple requests allows for more efficient, parallel processing. An XML generator 756 uses a request message DTD 740 and the client application request message 742 to generate an XML request message 754. To create the XML request message, for each request, an XML request string 702 is created, in step 718. Preferably, the XML request string 702 is encrypted in step 720 and, in step 722, XML request message 754 is formed. In step 724, a sender 768 transmits XML request message 768 to server cluster 130.

Several components included on the real-time tariff and import data system servers, i.e., server cluster 130, facilitate communication with client 102C. Server cluster 130 receives the XML request message 754 from sender 768. The received XML request message 754 is parsed by an XML server parser 744. A parser is a tool used for grammatical analysis, which includes a syntax analyzer, that can interpret tags and retrieve information from them. Generally, the parser performs on a document in accordance with a corresponding DTD, which contains a tag description used in the XML document being parsed. Thus, a DTD document (e.g., DTD request message document 740) specifies the particular XML format for XML request message 754, identifying the tags that may or may not appear in XML document 754.

XML server parser 744 decrypts the XML request string 702 contained within XML request message 754 and then parses XML request string 702. Parser 744 extracts input values and security attributes from the request XML request string 702, assuming security mechanisms are used. After the security attributes have been approved, the real-time tariff and import data system 120 matches the user input product code with the appropriate HS code in database 146, assuming a user-defined product code was not entered. If using an HS code, system 120 validates that the HS code is correct for the specified destination country. If an error occurs, an XML response string containing the error message is sent back to the client 102C. Errors may be caused by invalid XML request values, invalid XML request node names, invalid inputs or invalid security attributes, as examples.

Parsing XML request string 702 allows a request message object 764 to be created and passed to the real-time tariff and import data system application 138. The user's values, and any other needed values, are extracted and the duty calculation engine 412, tax calculation engine 418, and total landed cost engine 426 process the request, as required, in step 726, to produce a response message object 762. XML generator 758 generates an XML response message 752 from the response message object 762 and a DTD response message document 746. A sender 770 transmits the XML response message 770 to client device 102C.

Returning to flowchart 710 of FIG. 7B, client device 102C receives the XML response message 752, in step 728. XML client parser 766 on client 102C parses the XML response message 752, in step 730, to obtain the XML response string 704 and then decrypts the XML response string, in step 732. XML client parser 766 creates a response message 744 from XML response string 704 and DTD response message document 746 (which is also available to client 102C). Response message 744 includes the requested duty, tax, and/or total landed cost data and is passed to client application 780.

Implementation of the preferred approach to processing XML documents (i.e., requests and responses) takes place in several steps:

(1) Definition of DTD document 740 for requests from clients,

(2) Definition of DTD document for responses 746 from the real-time tariff and import data system 120, and

(3) Implementation of XML parsers (e.g., parsers 744 and 766), which retrieve data from XML documents and convert the data into objects.

As mentioned, a DTD document 740 is used to create the structure of the XML request string (see Appendix L). The DTD document 740 ensures that the request is properly formed for processing by the real-time tariff and import data system 120. The following is an example of a valid XML request message 754 prepared and sent by XML client 102C:

<!DOCTYPE TARRIFMESSAGE SYSTEM
“HTTP://WWW.WEBSITE.COM:7001/MESSAGE.DTD”>
<TARIFFMESSAGE ENCRYPTIONMETHOD= “1”

DTDVERSION = “1”>

<![CDATA[ENCODED XML REQUEST]]>
</TARIFFMESSAGE>

The Text attribute ([CDATA[ . . . ]]) in the TariffMessage request contains a valid XML request string encrypted with a secret key that is provided to clients. An example of a valid XML request string (before it is encoded) is as follows:

<DOCTYPE TFEEDREQUEST SYSTEM
“HTTP://WWW.WEBSITE.COM:7001/TARREQUEST.DTD”>
<TFEEDREQUEST>

PIN=“XXXX”
ORIGINCOUNTRY=“CA”
SHIPMENTCOUNTRY=“CA”
DESTINATIONCOUNTRY“CG”
OUTPUTFORMAT=“1”>

| | |
|---|---|
| <CURRENCY | TRANSACTIONCUR=“CAD” |
| | CONVERSIONCUR=“CAD”/> |
| <DTREQUEST | ACCESSCODE=“2” INPUTCODETYPE=“1” |

```
  PRODUCTCODE=“010111” VALUE=“500000”
  COSTOFTRANSPORT=“50”
  INSURANCECOST=“50” OTHERCOST=“50>
```

<UNITS>
<UNIT NBOFUNIT=“1” UNITCODE=“4”/>
</UNITS>
</DTREQUEST>

</TFEEDREQUEST>

An example of XML response string is as follows:

```
<!DOCTYPE TFEEDREPLYSYSTEM
  “HTTP://WWW.WEBSITE.COM/TARREPLY.DTD”>
<TFEEDREPLY>
<TFEEDREPLY STATUS=“0” HSCODE=“1212121212”
MESSAGE=“OK” NOTES=“”>
  <DUTY DUTY=“500”/>
</TFEEDREPLY>
```

2. Web (i.e., ActiveX/COM) Clients—The real-time tariff and import data system 120 accommodates Web clients 102A using ActiveX/COM components, as shown in FIGS. 8A-C. With this type of client, a standard Web browser 806 is used by the client 102A, as is shown in FIG. 8A. Using a browser, a client 102A generates a request 802, e.g., an HTML form, and transmits the request 802 to the real-time tariff and import data system 120. Request 802 is serviced by the application servers 130. Request 802 contains all of the required information for conducting duty, import tax, and/or total landed cost calculations, depending on the user's selected output. Request 802 is well formed, since the client is prompted to enter all inputs needed to process the request and the inputs are preferably validated. As discussed with respect to FIG. 4, a servlet 424 on server cluster 130 picks up request 802, retrieves the data (i.e., inputs) and processes the request by calculating the requested duty, import tax and/or total landed cost.

A more detailed view of the configuration of client 102A is shown in FIG. 8B. An ActiveX/COM component 810 is loaded onto client device 102A to make the functionality of the real-time tariff and import data system 120 available to the client application 820, via Web browser 806. Functionally, component 810 acts as a translator between the client's Web-based application 820 and the real-time tariff and import data system 120 functionality. Component 810 simplifies processing by translating client application requests into XML requests 802. All of the XML formatting and encryption is done by component 810. Loading component 810 on client 102A may require registration with the real-time tariff and import data system 120, depending on the embodiment. To use component 810, an encryption method is set internally, when encryption is used. The encryption method defines the encryption key to be used for communication with the real-time tariff and import data system 120. Setting the encryption method is accomplished using the appropriate “set” methods of component 810.

Additionally, inputs 812 entered via the client's Web-based application 820 are incorporated into XML request 802 using appropriate set methods of component 810. Use of such set methods for assigning attribute values is known in the art, so not discussed in detail herein. The following is a preferred embodiment of an interface definition used by the ActiveX/COM component 810 with client application 820:

interface ISingleRequestSession: IDispatch

```
{
  HRESULT ProcessRequest();
  HRESULT setEncryptionKey([in] BSTR EncryptionKey);
  HRESULT setEncryptionMethod([in] BSTR EncryptionMethod);
  HRESULT setDtdVersion([in] BSTR DtdVersion);
  HRESULT getHSCode([out,retval] BSTR* HSCode);
  HRESULT getStatus([out,retval] BSTR* Status);
  HRESULT getMessage([out,retval] BSTR* Message);
  HRESULT getCustomTarifRate([out,retval] BSTR*
```

CustomTarifRate);

```
  HRESULT getPerUnitCusTarif([out,retval] BSTR* PerUnitCusTarif);
  HRESULT getProductBaseUnit([out,retval] BSTR *
```

ProductBaseUnit);

```
  HRESULT getDutyAmount([out,retval] BSTR * DutyAmount);
  HRESULT getTaxCount([out,retval]int* TaxCount);
  HRESULT getCategory([in] int index,[out,retval] BSTR* Category);
  HRESULT getTaxRate([in] int index,[out,retval] BSTR* TaxRate);
  HRESULT getPerUnitTax([in]int index,[out,retval] BSTR*
  PerUnitTax);
  HRESULT getTaxBaseUnit([in] int index, [out,retval]
```

BSTR*TaxBaseUnit);

HRESULT getTaxAmount([in] int index,[out,retval] BSTR*

TaxAmount);

```
  HRESULT getTaxName([in] int index,[out,retval] BSTR* TaxName);
  HRESULT getSumTaxes([out,retval] BSTR* SumTaxes);
  HRESULT getValue([out,retval] BSTR* Value);
  HRESULT getCostOfTransport([out,retval] BSTR* CostOfTransport);
  HRESULT getInsuranceCost([out,retval] BSTR* InsuranceCost);
  HRESULT getOtherCosts([out,retval] BSTR* OtherCosts);
  HRESULT getTotalLandedCost([out,retval] BSTR* TotalLandedCost);
  HRESULT getServerAddress([out,retval] BSTR* ServerAddress);
  HRESULT setPinNumber([in] BSTR PinNumber);
  HRESULT setShipmentCountry([in] BSTR ShipmentCountry);
  HRESULT setOriginCountry([in] BSTR OriginCountry);
  HRESULT setDestinationCountry([in] BSTR DestinationCountry);
  HRESULT setOutputFormat([in] BSTR OutputFormat);
  HRESULT setProductCode([in] BSTR ProductCode);
  HRESULT setValue([in] BSTR Value);
  HRESULT setUnit([in] BSTR NbOfUnit, [in] BSTR UnitCode, [in] int
  UnitIndex);
  HRESULT setCostOfTransport([in] BSTR CostOfTransport);
  HRESULT setInsuranceCost([in] BSTR InsuranceCost);
  HRESULT setOtherCost([in] BSTR OtherCost);
  HRESULT setCurrency([in] BSTR Currency);
  HRESULT setConversionCurrency([in] BSTR ConversionCurrency);
  HRESULT setInputCodeType([in] BSTR InputCodeType);
  HRESULT setAccessCode([in] BSTR AccessCode);
  HRESULT getNotes([out,retval] BSTR* Notes);
  HRESULT getTaxNote([in] int index,[out,retval] BSTR* TaxNote);
```

FIG. 8C illustrates a client-side view of a method 850 of interaction between client 120A (with the ActiveX/COM component 810) and the real-time tariff and import data system 120. Component 810 receives inputs 812 and creates one or more corresponding requests 856A-C, in step 854, according to the appropriate DTD. Using the DTD minimizes the potential for XML errors, because the XML request string 802 built is inherently valid and well formed. Encryption and decryption will also be valid, minimizing the potential for encryption errors. As an example, the request 856A, in step 858, is formed into an XML request string 802, using a ProcessRequest( ) method of component 810. Component 810 sends XML request string 802 to server 132 and/or 134.

In step 860, the real-time tariff and import data system 120 processes the requests and returns an XML response to component 810. The response will be in the form of an XML response string 804 that provides duty, tax, and/or total landed cost values, in accordance with the user's selected output. Component 810 decrypts the XML response 804 with an appropriate encryption key (i.e., the public key of system 120). The XML response string 804 is then parsed by component 810. All values are extracted from the XML response string and set in the component. The client application retrieves desired values from the response by using the appropriate “get” method 814 for each value needed. Each response value has its appropriate “get” method. The values are combined in step 864 and provided to the client application 820, in step 866.

3. Java Clients—The real-time tariff and import data system 120 provides a set of Java classes, embodied in Tariff.jar 910, loaded on the client 102B that prepares and sends an XML request 902 to the server 132 or 134, as is shown in FIG. 9A. An application (e.g., client application 920) uses the Java classes 910 by calling one method to pass a request object 912 and by receiving a reply object 914. Using Java to prepare and send XML request string 902 is similar to the use of ActiveX/COM component 810 discussed above. Tariff.jar 910 acts as a translator between client application 920 and the real-time tariff and import data system 120. That is, Java classes 910 allow XML requests to be sent by client 102B and XML responses to be received by client 102B.

To use the Java classes 910, the classes must first be added to the client's class path or project environment, which makes the Java classes available to the client application 920. An encryption method and encryption key must also be set in the Tariff.jar 910 classes to facilitate secure communications. Thereafter, processing a request merely requires calling one method, ProcessRequest( ), and passing a request object containing the input parameters discussed previously (see also Appendix H).

The ProcessRequest( ) method of Tariff.jar 910 builds a valid XML request string from the user's inputs. This approach minimizes XML errors, since the XML request string will necessarily be valid and well formed according to its DTD. Also, given that the ProcessRequest( ) method builds the request, encryption and decryption will also be valid, minimizing encryption errors. After building the XML request string 902, the Java classes 910 send the XML request to servers 132 and 134, receives the XML response message, and decrypts the XML response string 904 therefrom. The Java classes 910 decrypt the XML response string 904 with the appropriate encryption key (e.g., system 120's public key).

The Java classes 910 parse the XML response string. All values are extracted from the XML response string 904 and set in the Java classes. A response object 914 is then returned to the client application 920. These values can be retrieved by the client application 920 by calling the appropriate “get” methods of the response object. Each response value has its appropriate “get” method. All values can be retrieved and output in client application 920.

FIG. 9B shows a client-side view of a method 950 of interaction between a client application 920 and server cluster 130. In step 952, the client application 920 gathers the inputs from the user and generates one or more request objects, 956A-C. In step 958, the Java classes 910 receive the request object 912 (or 956A) and gets the needed inputs from the request object and then creates an XML request string 902. The request string 902 is then sent (in an XML request message) to the real-time tariff and import data system 120 servers 132 and 134, which processes the request, in step 960. An XML response string (in a response message) is then returned to the Java classes 910 from the servers 132 and 134. The Java classes 910 get data from the XML response string and form response objects 914, in step 962. The response includes the duty, tax, and/or total landed cost, as requested by the user. The client application 920 retrieves values from the response objects 914 by calling the appropriate “get” methods and combines the values, in step 964. The values are then output to the client application 920, in step 966.

Part III—Calculations

The following is the preferred embodiment of the manner of calculating duties and taxes associated with an international transaction. The methods are implemented by the duty calculation engine 412, import tax calculation engine 418, and total landed cost calculation engine 426, previously discussed with respect to FIG. 4. The duty calculation engine 412 accesses relevant tariff rates for a specified product and destination country from the database 146 and applies the lowest of such applicable rates to arrive at a duty calculation. The import tax calculation engine 418 accesses relevant databases of country specific import tax rates, charges and fees and applies them to arrive at import tax costs. The total landed cost calculation engine 426 determines the total landed cost from the duty calculation and the import tax calculation, and any other relevant costs (e.g., transportation and insurance costs).

The inputs for the various engines are gathered from the XML request process previously described. The inputs for the various engines are described above in Part II and Appendix H. Validation of the inputs is performed as the data is input into appropriate fields of, for example, a Web-based request form. The validation occurs by testing inputs against field-based validation criteria, described in Appendix H. Appendix I identifies the returned values for each of the ten (10) possible output formats of the preferred embodiment.

1. Duty (or Tariff) Calculation

The following tables identify the steps taken by the duty calculation engine 412 to calculate the duty (or tariffs) for a given international transaction. At a macro level, the steps include selecting a duty rate, converting currencies, and calculating the duty fee. The tables include object oriented pseudo code describing calls and method steps used in the process and also describes error codes applicable to the various steps.

Table 4 below shows the steps for selecting a duty rate for a given set of inputs.

TABLE 4
Duty Rate Selection

| Step | Processing |
|---|---|
| 1. Verify | Tables: |
| HS | _TariffDescription = (Country.CountryCode of |
| code | destination country) + “TarrifDescription” |
| | Information: |
| | _TariffDescription.HSCode |
| | _TariffDescription.UnitCode |
| | _TariffDescription.ApplicableTariff |
| | Selection criteria: |
| | _TariffDescription.HS Code = HS Code |
| | Error processing: |
| | If no record is returned: |
| | Error code: S110 - The HS code is not in the HS code list for |
| | the destination country. |
| 2. Verify | Tables: |
| tariff | _TariffCode = (Country.CountryCode of destination |
| preference | country) + “TariffCode” |
| | _TariffScheme = (Country.CountryCode of destination |
| | country) + “TariffScheme” |
| | Information: |
| | _TariffCode.TariffCodeID |
| | _TariffCode.Acronym |
| | _TariffCode.GeneralTariff |
| | _TariffScheme.CountryCode (optional) |
| | Selection criteria: |
| | _TariffScheme.CountryCode = Country.CountryCode of |
| | country of origin of goods |
| | _TariffCode.Acronym in |
| | _TariffDescription.ApplicableTariff |
| | Error processing: |
| | If the Country code is not in the items returned by the |
| | request, the item containing the general tariff must be |
| | selected. |
| | Error code: S120 - No Tariff code available. |
| | Error code S120 should be brought to the attention of the |
| | system administrator. |
| 3. Select | Required: |
| Duty | The specified HS code must be a valid HS code (see Step |
| Rate | 1). |
| | There is an applicable tariff code |
| | (_TariffCode.TariffCodeID <> NULL) (see Step 2). |
| | Table: |
| | _TariffData = (Country.CountryCode of destination |
| | country) + “TariffData” |
| | Information: |
| | _TariffData.AddValoremRate |
| | _TariffData.PerUnit |
| | _TariffData.CalculationMethod |
| | Selection criteria: |
| | _TariffData.HSCode = _TariffDescription.HSCode |
| | _TariffData.TariffCodeID = _TariffCode.TariffCodeID |
| | Selecting a tariff: |
| | If more than one rate is available, the application selects the |
| | highest. |
| | Error processing: |
| | If no tariff is returned: |
| | Error code: S130 - No tariff code available for HS code |
| | specified in request. |
| | Error code S130 should be brought to the attention of the |
| | system administrator. |
| 4. Convert | Required for output formats 1, 3, 7 and 9 (See Appendix I) |
| per-unit | If the conversion currency of the request |
| rate | (Request.ConversionCur) is the same as the country's |
| | customs tariff currency (Country.TariffsCurrency) Then |
| | ConvertedPerUnitRate = _TariffData.PerUnit |
| | Else If the country's customs tariff currency is “USD” Then |
| | ConvertedPerUnitRate = Conversion of per-unit rate from |
| | “USD” to the conversion currency of the request (See |
| | Table 5) |
| | Else |
| | USDPerUnitRate = Conversion of per-unit rate to “USD” (See |
| | Table 5) |
| | ConvertedPerUnitRate = Conversion from USDPerUnitRate to |
| | the conversion currency of the request (See Table 5) |

Table 5 shows the steps for converting between currencies among countries, which is useful in the calculations, since typically the origin country, shipment country, and destination country may have different currencies.

TABLE 5
Currency Conversion

| Step | Processing |
|---|---|
| 1. Find rate | Tables: |
| | Country |
| | Currency |
| | Information: |
| | Currency.Rate |
| | Selection criteria: |
| | Country.CountryCode = <Country ISO code> |
| | Currency.Code = <Currency ISO code> |
| | Note - the currency ISO code can come from: |
| | The request (TransactionCur; ConversionCur) |
| | The Country table (Country.CurrencyCode; |
| | Country.TariffsCurrency) |
| | Error processing: |
| | If no item is returned: |
| | S210 - No exchange rate available for the following |
| | currency code: <Currency ISO code>. |
| | Error code S210 should be brought to the attention of the |
| | system administrator. |
| 2. Calculate | To convert to USD (as an example) |
| converted | Amount / Currency.Rate |
| amount | To convert from USD |
| | Amount* Currency.Rate |

Table 6 shows the steps for calculating the duty (or tariff), which incorporates the steps in Table 4 for selecting a duty (or tariff) and the steps of Table 5 for converting currencies.

TABLE 6
Duty Fee Calculation

| Step | Processing |
|---|---|
| 1. Select a | See Table 4. |
| tariff | |
| 2. Identify | Table: |
| applicable | Country |
| basis for | CalculationBase |
| duty | Information: |
| calculation | CalculationBase.CostOfGoods |
| | CalculationBase.Transport |
| | CalculationBase.InsuranceCost |
| | CalculationBase.OtherCost |
| | Selection criteria: |
| | Country.CountryCode = Destination Country code |
| | CalculationBase.CaculationBaseID = |
| | Country.DutyFeeCalculationBase |
| 3. Calculate | Applicable Fees = 0 |
| applicable | If CalculationBase.CostOfGoods is TRUE Then |
| duty | Applicable Fees = Request.PriceOfGoods |
| | If CalculationBase.Transport is TRUE Then |
| | Applicable Fees = Applicable Fees + |
| | Request.CostOfTransport |
| | If CalculationBase.InsuranceCost is TRUE Then |
| | Applicable Fees = Applicable Fees + |
| | Request.InsuranceCost |
| | If CalculationBase.OtherCost is TRUE Then |
| | Applicable Fees = Applicable Fees + Request.OtherCost |
| 4. Convert | If the transaction currency (Request.TransactionCurrency) |
| applicable | is the same as the country's customs tariff currency |
| fees | (Country.TariffsCurrency) Then |
| | ConvertedApplicableFees = ApplicableFees |
| | Else If the transaction currency is “USD” Then |
| | ConvertedApplicableFees = Conversion of applicable |
| | fees from “USD” to the tariff currency (See Table 5) |
| | Else |
| | USDApplicableFees = Conversion of applicable fees to |
| | “USD” (See Table 5) |
| | ConvertedApplicableFees = Conversion of USD applicable |
| | fees to the tariff currency (See Table 5) |
| 5. Convert | Tables: |
| quantities | UnitCode |
| | _TariffDescription |
| | Information: |
| | UnitCode.UnitType |
| | UnitCode.ConversionFactor |
| | _TariffDescription.UnitCode |
| | Methods: |
| | If Request.ProductBaseUnit = |
| | _TariffDescription.UnitCode, Then |
| | ConvertedQuantity = Request.NbOfUnit |
| | Else If the unit type of Request.ProductBaseUnit is |
| | different from the type associated with the product unit |
| | measure; Then |
| | Error code: S560 - The base unit of the products is |
| | incompatible with the base unit specified in the request. |
| | Else ConvertedQuantity = Request.NbOfUnit* |
| | UnitCode.ConversionFactor |
| | Remarks: To find out the base unit type, refer to the |
| | UnitCode.UnitType field. |
| 6. Calculate | AddValoremFee = (ConvertedApplicableFees* |
| duty | _TariffData.AddValoremRate) |
| | PerUnitFee = (ConvertedQuantity*_TariffData.PerUnit) |
| | If the tariff calculation method is “Applied Both” |
| | (_TariffData.CalculationMethod = 10 Then |
| | DutyFee = AddValoremFee + PerUnitFee |
| | Else If the tariff calculation method is “Applied Greatest” |
| | (_TariffData.CalculationMethod = 20) Then |
| | If AddValoremFee > PerUnitFee Then |
| | DutyFee = Add ValoremFee |
| | Else |
| | DutyFee = PerUnitFee |
| | Else If the tariff calculation method is “Applied Smallest” |
| | (_TariffData.CalculationMethod = 30) Then |
| | If Add ValoremFee > PerUnitFee Then |
| | DutyFee = PerUnitFee |
| | Else |
| | DutyFee = AddValoremFee |
| 7. Convert | If the conversion currency of the request |
| duty | (Request.ConversionCur) is the same as the country's |
| | customs tariff currency (Country.TariffsCurrency) Then |
| | ConvertedDutyFee = DutyFee |
| | Else If the country's customs tariff currency is “USD” Then |
| | ConvertedDutyFee = Conversion of duty fee from |
| | “USD” to the conversion currency of the request |
| | (See Table 5) |
| | Else |
| | USDDutyFee = Conversion of duty fee from “USD” (See |
| | Table 5) |
| | ConvertedDutyFee = Conversion of USD duty fee to the |
| | conversion currency of the request (See Table 5) |

2. Tax Calculation

The following tables identify the steps taken by the import tax calculation engine 418 to calculate the tax for a given international transaction. At a macro level, the steps include selecting a tax rate and calculating the applicable taxes. The tables include object oriented pseudo code describing calls and method steps, and also describes error codes for the various steps.

Table 7 below, shows the steps for selecting a tax rate for a given set of inputs.

TABLE 7
Tax Rate Selection

| Step | Processing |
|---|---|
| 1. Verify HS | Table: |
| code | HSDescription |
| | Information: |
| | HSDescription.HSCode |
| | Selection criteria: |
| | HSDescription.HSCode = Input.HS Code[1:6] |
| | Error processing: |
| | If no record is returned: |
| | Error code: S410-The HS code is not in the standard |
| | HS code list. |
| 2.Identify | Tables: |
| categories | HSCategoryInterval |
| | Information: |
| | HSCategoryInterval.CategoryID |
| | Selection criteria: |
| | HSCategoryInterval.HSFrom >= Input.HS Code[1:6] |
| | HSCategoryInterval.HSTo <= Input.HSCode[1:6] |
| | Error processing: |
| | If no category is returned: |
| | Error code: S420-The product does not belong to any |
| | product category. |
| | Error code S420 should be brought to the attention of the |
| | system administrator. |
| 3. Select | Tables: |
| applicable | ApplicableTax |
| taxes | Tax |
| | Information: |
| | Tax.TaxeAcronym |
| | Tax.TaxeRate |
| | Tax.TaxePerUnit |
| | Tax.TaxeUnitBase |
| | Method: |
| | For each category identified in the previous step: |
| | Select all taxes applicable to the category. |
| | Eliminate those taxes that were selected more than |
| | once (duplicates). |
| 4. Convert | Applicable to output formats 4, 6, 7 and 9 |
| per-unit | For each tax selected, the applicable per-unit tax must |
| taxes | be converted if it is greater than zero. |
| | If the conversion currency of the request |
| | (Request.ConversionCurrency) is the same as the |
| | country's customs tariff currency |
| | (Country.TariffsCurrency) Then |
| | ConvertedPerUnitTax = Taxe.TaxPerUnit |
| | Else If the country's customs tariff currency is |
| | “USD” Then ConvertedPerUnitTax = |
| | Conversion of per-unit tax from “USD” to the |
| | conversion currency of the request (See Table 5) |
| | Else |
| | USDPerUnitTax = Conversion of per-unit tax to “USD |
| | (See Table 5) |
| | ConvertedPerUnitTax = Conversion of USDPerUnitTax |
| | to the conversion currency of the request (See Table 5) |

Table 8 shows the steps for calculating the import tax, which incorporates the steps in Table 6 for selecting a tax rate and the steps of Table 5 for converting currencies.

| Step | Processing |
|---|---|
| 1. Select | See Table 7. |
| applicable taxes | |
| 2. Identify | Tables: |
| applicable | Tax |
| basis for tax | CalculationBase |
| calculation | Information: |
| | CalculationBase.CostOfGoods |
| | CalculationBase.Transport |
| | CalculationBase.InsuranceCost |
| | CalculationBase.OtherCost |
| | CalculationBase.DutyFee |
| | Selection criteria: |
| | CalculationBase.CalculationBaseID = |
| | Tax.TaxCalculationBase |
| 3. Calculate taxable | Taxable Fees = 0 |
| fees | If CalculationBase.CostOfGoods is TRUE Then |
| | Taxable Fees = Taxable Fees + Request.Value |
| | If CalculationBase.Transport is TRUE Then |
| | Taxable Fees = Taxable Fees + |
| | Request.CostOfTransport |
| | If CalculationBase.InsuranceCost is TRUE Then |
| | Taxable Fees = Taxable Fees + |
| | Request.InsuranceCost |
| | If CalculationBase.OtherCost is TRUE Then |
| | Taxable Fees = Taxable Fees + |
| | Requête.OtherCost |
| | If CalculationBase.DutyFees is TRUE Then |
| | Taxable Fees = Taxable Fees + |
| | Calculated Duty Fee (See Table 6) |
| 4. Calculate surtax | Note: It is important to verify that a given tax is not |
| on taxes | applied as a surtax on a second tax which is itself |
| | applied to the first tax. In the event of such a |
| | loop, an error code must be returned. |
| | Error code: S440-System error. Unable to calculate |
| | taxes. |
| | Error code S440 should be brought to the attention |
| | of the system administrator along with the |
| | information pertaining to the request. |
| | Calculate the tax with surtax. |
| | Add the resulting amount to the Taxable Fees. |
| | Repeat the operation for all taxes on which a surtax |
| | applies. |
| 5. Convert | If the transaction currency (Request.TransactionCur) |
| taxable fees | is the same as the country's customs tariff |
| | currency (Country.TariffsCurrency) Then |
| | ConvertedTaxableFees = ApplicableFees |
| | Else If the transaction currency is “USD” Then |
| | ConvertedTaxableFees = Conversion of taxable |
| | fees from “USD” to the tariff currency |
| | (See Table 5) |
| | Else |
| | USDTaxableFees = Conversion of to “USD” |
| | (See Table 5) |
| | ConvertedTaxableFees = Conversion of USD |
| | taxble fees to the tariff currency (See Table 5) |
| 6. Convert | Table: |
| quantities | UnitCode |
| | Tax |
| | Information: |
| | UnitCode.UnitType |
| | UnitCode.ConversionFactor |
| | Tax.UnitCode |
| | Methods: |
| | If Request.ProductBaseUnit = Tax.UnitCode |
| | Then ConvertedQuantity = Request.NbOfUnit |
| | Else If the unit type of Request.ProductBaseUnit |
| | is different from the type associated with the |
| | product base unit Then |
| | Error code: S560-The base unit of the products is |
| | incompatible with the base unit specified in the |
| | request. |
| | Else ConvertedQuantity = Request.NbOfUnit* |
| | UnitCode.ConversionFactor |
| | Remarks: |
| | To find out the base unit type, refer to the |
| | UnitCode.UnitType field. |
| 7. Calculate | TransactionTax = (Converted Taxable Fees * |
| taxes | Tax.TaxeRate) |
| | UnitTax = (ConvertedQuantity * Tax.TaxPerUnit) |
| | If the tax calculation method is “Apply Both” |
| | (Tax.CalculationMethod) = 10 Then |
| | Tax = TransactionTax + Unit Tax |
| | Else If the tax calculation method is |
| | “Applied Greatest” |
| | (Tax.CalculationMethod = 20) Alors |
| | If Transaction Tax> Unit Tax Then |
| | Tax = Transaction Tax |
| | Else |
| | Tax = Unit Tax |
| | Else If the tax calculation method is |
| | “Applied Smallest” |
| | (Tax.CalculationMethod = 30) Then |
| | If Transaction Tax > Unit Tax Then |
| | Tax = Unit Tax |
| | Else |
| | Tax = Transaction Tax |

APPENDIX A/B-Country and Currency Codes
Following is a list of country and currency codes:

| | Country | | Currency |
|---|---|---|---|
| Country | Code | Currency | Code |
| Andorra | ad | Andorran Peseta | ADP |
| United Arab Emirates | ae | Utd. Arab Emir. Dirham | AED |
| Afghanistan | af | Afghanistan Afghani | AFA |
| Antigua and Barbuda | ag | Eastern Carribean Dollar | XCD |
| Anguilla | ai | Eastern Carribean Dollar | XCD |
| Albania | al | AlbanianLek | ALL |
| Netherlands Antilles | an | NL Antillian Guilder | ANG |
| Angola | ao | Angolan New Kwanza | AON |
| Antartica | aq | US Dollar | USD |
| Argentina | ar | Argentine Peso | ARS |
| American Samoa | as | US Dollar | USD |
| Austria | at | Euro | EUR |
| Australia | au | Australian Dollar | AUD |
| Aruba | aw | Aruban Florin | AWG |
| Bosnia and Herzegovina | ba | Babraini Dinar | BHD |
| Barbados | bb | Barbados Dollar | BBD |
| Bangladesh | bd | Bangladeshi Taka | BDT |
| Belgium | be | Euro | EUR |
| Burkina Faso | bf | CFA Franc BEAC | XAF |
| Bulgaria | bg | Bulgarian Lev | BGL |
| Bahrain | bh | Bahraini Dinar | BHD |
| Burundi | bi | Burundi Franc | BIF |
| Benin | bj | CFA Franc BEAC | XAF |
| Bermuda | bm | Bermudian Dollar | BMD |
| Brunei Darussalam | bn | Brunei Dollar | BND |
| Bolivia | bo | Bolivian Boliviano | BOB |
| Brazil | br | Brazilian Real | BRL |
| Bahamas | bs | Bahamian Dollar | BSD |
| Bhutan | bt | Bhutan Ngultrum | BTN |
| Bouvet Island | bv | Norwegian Kroner | NOK |
| Botswana | bw | Botswana Pula | BWP |
| Belize | bz | Belize Dollar | BZD |
| Canada | ca | Canadian Dollar | CAD |
| Cocos (Keeling) Islands | cc | Australian Dollar | AUD |
| Congo (Kinshasa | cd | CFA Franc BEAC | XAF |
| Central African Republic | cf | CFA Franc BEAC | XAF |
| Congo (Brazzaville) | cg | CFA Franc BEAC | XAF |
| Switzerland | ch | Swiss Franc | CHF |
| Cote d'Ivoire | ci | CFA Franc BEAC | XAF |
| Cook Islands | ck | New Zealand Dollar | NZD |
| Chile | cl | Chilean Peso | CLP |
| Cameroon | cm | CFA Franc BEAC | XAF |
| China | cn | Chinese Yuan Renminbi | CNY |
| Colombia | co | Colombian Peso | COP |
| Costa Rica | cr | Costa Rican Colon | CRC |
| Cuba | cu | Cuban Peso | CUP |
| Cape Verde | cv | Cape Verde Escudo | CVE |
| Christmas Islands | cx | Australian Dollar | AUD |
| Cyprus | cy | Cyprus Pound | CYP |
| Czech Republic | cz | Czech Koruna | CSK |
| Germany | de | Euro | EUR |
| Djibouti | dj | Djibouti Franc | DJF |
| Denmark | dk | Euro | EUR |
| Dominica | dm | Eastern Carribean Dollar | XCD |
| Domincan Republic | do | Dominican Peso | DOP |
| Algeria | dz | Algerian Dinar | DZD |
| Ecuador | ec | Ecuador Sucre | ECS |
| Estonia | ee | Estonian Kroon | EEK |
| Egypt | eg | Egyptian Pound | EGP |
| Western Sahara | eh | Moroccan Dirham | MAD |
| Eritrea | er | Russian Rouble | RUB |
| Spain | es | Euro | EUR |
| Ethiopia | et | Ethiopian Birr | ETB |
| European Union | eu | Euro | EUR |
| Finland | fi | Euro | EUR |
| Fiji | fj | Fiji Dollar | FJD |
| Falkiand Islands | fk | Falkland Islands Pound | FKP |
| (Malvinas) | | | |
| Micronesia, | fm | US Dollar | USD |
| Federative States Of | | | |
| Faroe Islands | fo | Danish Krone | DKK |
| France | fr | Euro | EUR |
| Gabon | ga | CFA Franc BEAC | XAF |
| United Kingdom | gb | Euro | EUR |
| Grenada | gd | Eastern Carribean Dollar | XCD |
| Ghana | gh | Ghanaian Cedi | GHC |
| Gibraltar | gi | United Kingdom Pound | GBP |
| Greenland | gl | Danish Krone | DKK |
| Gambia | gm | Gambian Dalasi | GMD |
| Guinea | gn | Guinea Franc | GNF |
| Guadeloupe | gp | French Franc | FRF |
| Equatorial Guinea | gq | CFA Franc BEAC | XAF |
| Greece | gr | Euro | EUR |
| Georgia South | gs | United Kingdom Pound | GBP |
| Guatemala | gt | Guatemalan Quetzal | GTQ |
| Guam | gu | US Dollar | USD |
| Guinea-Bissau | gw | CFA Franc BEAC | XAF |
| Guyana | gy | Guyanan Dollar | GYD |
| Hong Kong | hk | Hong Kong Dollar | HKD |
| Heard and MacDonald | hm | Australian Dollar | AUD |
| Islands | | | |
| Honduras | hn | Honduran Lempira | HNL |
| Croatia | hr | Croatian Kuna | HRK |
| Haiti | ht | Haitian Gourde | HTG |
| Hungary | hu | Hungarian Forint | HUF |
| Indonesia | id | Indonesian Rupiah | IDR |
| Ireland | ie | Euro | EUR |
| Israel | il | Israeli New Shekel | ILS |
| India | in | Indian Rupee | INR |
| Iraq | iq | Iraqi Dinar | IQD |
| Iran | ir | Iranian Rail | IRR |
| Iceland | is | Iceland Krona | ISK |
| Italy | it | Euro | EUR |
| Jamaica | jm | jamaican Dollar | JMD |
| Jordan | jo | Jordanian Dinar | JOD |
| Japan | jp | Japanese Yen | JPY |
| Kenya | ke | Kenyan Shilling | KES |
| Cambodia (Kampuchea) | kh | Kampuchean Riel\| | KHR |
| | | Cambodian Riel | |
| Kiribati | ki | Australian Dollar | AUD |
| Comoros | km | Comoros Franc | KMF |
| St Kitts and Nevis | kn | Eastern Carribean Dollar | XCD |
| Korea, North | kp | North Korean Won | KPW |
| Korea, South | kr | Korean Won | KRW |
| Kuwait | kw | Kuwaiti Dinar | KWD |
| Cayman Islands | ky | Cayman Islands Dollar | KYD |
| Kazakhstan | kz | Kazakhstan Tenge | KZT |
| Laos | la | Lao Kip | LAK |
| Lebanon | lb | Lebanese Pound | LBP |
| Saint Lucia | lc | Eastern Carribean Dollar | XCD |
| Liechtenstein | li | Swiss Franc | CHF |
| Sri Lanka | lk | Sri Lanka Rupee | LKR |
| Liberia | lr | Liberian Dollar | LRD |
| Lesotho | ls | Lesotho Loti | LSL |
| Lithuania | lt | Lithuanian Litas | LTL |
| Luxembourg | lu | Euro | EUR |
| Latvia | lv | Latvian Lats | LVL |
| Libya | ly | Libyan Dinar | LYD |
| Morocco | ma | Moroccan Dirham | MAD |
| Monaco | mc | French Franc | FRF |
| Madagascar | mg | Malaysian Ringgit | MYR |
| Marshall Islands | mh | US Dollar | USD |
| Mali | ml | CFA Franc BEAC | XAF |
| Myanmar (Burma) | mm | Myanmar Kyat | MMK |
| Mongolia | mn | Mongolian Tugrik | MNT |
| Macau | mo | Macau Pataca | MOP |
| Northern Mariana Islands | mp | US Dollar | USD |
| Martinique | mq | French Franc | FRF |
| Mauritania | mr | Mauritanian Ouguiya | MRO |
| Montserrat | ms | Eastern Carribean Dollar | XCD |
| Malta | mt | Maltese Lira | MTL |
| Mauritius | mu | Mauritius Rupee | MUR |
| Maldives | mv | Maldive Rufiyaa | MVR |
| Malawi | mw | Malawi Kwacha | MWK |
| Mexico | mx | Mexican Peso | MXP |
| Malaysia | my | Malaysian Ringgit | MYR |
| Mozambique | mz | Mozambique Metical | MZM |
| Namibia | na | Namibia Dollar | NAD |
| Niger | ne | CFA Franc BEAC | XAF |
| Norfolk Island | nf | Australian Dollar | AUD |
| Nigeria | ng | Nigerian Naira | NGN |
| Netherlands | nl | Euro | EUR |
| Norway | no | Norwegian Kroner | NOK |
| Nepal | np | Nepalese Rupee | NPR |
| Nauru | nr | Australian Dollar | AUD |
| Neutral Zone | nt | Kuwaiti Dinar | KWD |
| Niue | nu | New Zealand Dollar | NZD |
| New Zealand | nz | New Zealand Dollar | NZD |
| Oman | om | Omani Rial | OMR |
| Panama | pa | Panamanian Balboa | PAB |
| Peru | pe | Peruvian Nuevo Sol | PEN |
| Papua New Guinea | pg | Papua New Guinea Kina | PGK |
| Philippines | ph | Philippine Peso | PHP |
| Pakistan | pk | Pakistan Rupee | PKR |
| Poland | pl | Polish Zloty | PLZ |
| St Pierre and Miquelon | pm | French Franc | FRF |
| Pitcaim Island | pn | New Zealand Dollar | NZD |
| Puerto Rico | pr | US Dollar | USD |
| Portugal | pt | Portuguese Escudo | PTE |
| Palau | pw | US Dollar | USD |
| Paraguay | py | Paraguay Guarani | PYG |
| Qatar | qa | Qatari Rial | QAR |
| Reunion | re | French Franc | FRF |
| Romania | ro | Romanian Leu | ROL |
| Russian Federation | ru | Russian Rouble | RUB |
| Saudi Arabia | sa | Saudi Riyal | SAR |
| Solomon Islands | sb | Australian Dollar | AUD |
| Seychelles and | sc | Seychelles Rupee | SCR |
| Dependensies | | | |
| Sudan | sd | Sudanese Dinar | SDD |
| Sweden | se | Euro | EUR |
| Singapore | sg | Singapore Dollar | SGD |
| St Helena | sh | United Kingdom Pound | GBP |
| Slovenia | si | Slovenian Tolar | SIT |
| Svalabard and Jan Mayen | sj | Norwegian Kroner | NOK |
| Islands | | | |
| Slovakia | sk | Slovak Koruna | SKK |
| Sierra Leone | sl | Sierra Leone Leone | SLL |
| San Marino | sm | Italian Lira | ITL |
| Senegal | sn | CFA Franc BEAC | XAF |
| Somalia | so | Somali Shilling | SOS |
| Suriname | sr | Suriname Guilder | SRG |
| Sao Tome and Principe | st | Sao Tome/Principe | STD |
| | | Dobra | |
| El Salvador | sv | El Salvador Colon | SVC |
| Syria | sy | Syrian Pound | SYP |
| Swaziland | sz | Swaziland Lilangeni | SZL |
| Turks and Caiscos | tc | US Dollar | USD |
| Islands | | | |
| Chad | td | CFA Franc BEAC | XAF |
| French Southern | tf | French Franc | FRF |
| Territories | | | |
| Togo | tg | CFA Franc BEAC | XAF |
| Thailand | th | Thai Baht | THB |
| Tokelau | tk | New Zealand Dollar | NZD |
| Tunisia | tn | Tunisian Dinar | TND |
| Tonga | to | Tongan Pa'anga | TOP |
| Turkey | tr | TUrkish Lira | TRL |
| Trinidad and Tobago | tt | Trinidad/Tobago Dollar | TTD |
| Tuvalu | tv | Australian Dollar | AUD |
| Taiwan | tw | Taiwan Dollar | TWD |
| Tanzama | tz | Tanzanian Shilling | TZS |
| Ukraine | ua | Ukraine Hryvrna | UAG |
| Uganda | ug | Uganda Shilling | UGS |
| United States Minor | um | US Dollar | USD |
| Outlying Islands | | | |
| United States | us | US Dollar | USD |
| Uruguay | uy | Uruguayan Peso | UYP |
| Vatican City | va | Italian Lira | ITL |
| Saint Vincent-Grenadines | vc | Eastern Carribean Dollar | XCD |
| Venezuela | ve | Venezuelan Bolivar | VEB |
| British Virgin Island | vg | US Dollar | USD |
| Virgin Islands of the | vi | US Dollar | USD |
| United States | | | |
| Viet Nam | vn | Vietnamese Dong | VND |
| Vanuatu | vu | Vanuatu Vatu | VUV |
| Wallis and Futuna | wf | Central Pacific Franc | CFP |
| Islands | | | |
| Samoa | ws | Samoan Tala | WST |
| Yugoslavia | yu | Yugoslav Dinar | YUN |
| South Africa | za | South African Rand | ZAR |
| Zambia | zm | Zambian Kwacha | ZMK |
| Zimbabwe | zw | Zimbabwe Dollar | ZWD |

APPENDIX C-Unit Codes
Following is a list of unit codes:

| | | Unit |
|---|---|---|
| Product Base Unit | Code | Type |
| % PLATO/HECTOLITER | 154 | 23 |
| % PLATO/LITER | 39 | 23 |
| % VOL PER HECTOLITRE | 102 | 40 |
| % VOL PER IMPERIAL GALLON | 103 | 40 |
| % VOL PER LITRE | 98 | 40 |
| % VOL PER US GALLON | 107 | 40 |
| 1 000 000 UNITS | 182 | 1 |
| 1,000,000 STICKS OF TOBACCO | 165 | 2 |
| 10 UNITS | 105 | 1 |
| 100 BOXES | 203 | 34 |
| 100 CONTAINERS | 179 | 1 |
| 100 CUBIC METERS | 83 | 3 |
| 100 FEETS | 160 | 5 |
| 100 KILOGRAMS | 56 | 2 |
| 100 KILOGRAMS NET/EDA | 73 | 9 |
| 100 KILOGRAMS NET/MAS | 95 | 9 |
| 100 KILOGRAMS PER 1% BY WEIGHT OF SUCROSE | 212 | 543 |
| 100 KILOGRAMS/BR (Gross) | 106 | 15 |
| 100 KILOGRAMS/NET MAS (Net weight on dry matter) | 75 | 12 |
| 100 KILOGRAMS/NET SACCHARINE | 74 | 10 |
| 100 METERS | 66 | 5 |
| 100 POUNDS | 64 | 2 |
| 100 UNITS | 50 | 1 |
| 1000 INCHES | 161 | 5 |
| 1000 CUBIC METERS | 97 | 3 |
| 1000 CUBIC METERS/DAY | 130 | 22 |
| 1000 KILOLITERS | 46 | 4 |
| 1000 KILOWATTS | 67 | 30 |
| 1000 UNITS | 48 | 1 |
| 2 UNITS | 183 | 1 |
| 20 UNITS | 144 | 1 |
| 30 METERS | 54 | 5 |
| 440 CUBIC CENTIMETERS | 139 | 3 |
| 5 UNITS | 51 | 1 |
| 50 GRAMS | 145 | 2 |
| 50 UNITS | 60 | 1 |
| 5000 UNITS | 180 | 1 |
| BARREL (BEER AND FERMENTED ALCOHOL) | 59 | 4 |
| BARREL (PETROLEUM) | 49 | 36 |
| BDU OF 1089.6 KG | 187 | 29 |
| BECQUIEREL | 196 | 7 |
| bidon (ne pas utiliser) | 888 | 0 |
| BOTTLE | 190 | 1 |
| BOX | 197 | 3 |
| BTU (HEATING CAPACITY) | 134 | 45 |
| CALORIE (HEATING CAPACITY) | 133 | 45 |
| CARAT | 33 | 2 |
| CC (kilowatt-power * 26.667, used for electrical engines) | 131 | 4 |
| CENTILITER | 25 | 4 |
| CENTIMETER | 20 | 5 |
| CIGARETTES, CIGARS, CIGARILLOS LENGHT | 129 | 43 |
| (inches) | | |
| CIGARETTES, CIGARS, CIGARILLOS LENGHT (mm) | 112 | 43 |
| CL OF PURE ALCOHOL | 177 | 18 |
| CT/L (Hull capacity) | 148 | 35 |
| CUBIC CENTIMETER | 36 | 3 |
| CUBIC CENTIMETER (CC) OF ENGINE | 99 | 21 |
| DISPLACEMENT | | |
| CUBIC FEET | 28 | 3 |
| CUBIC METER | 31 | 3 |
| CUBIC YARD | 29 | 3 |
| CURRIE | 92 | 7 |
| DECALITRE | 30 | 4 |
| DECILITRE | 185 | 4 |
| DECIMETER | 21 | 5 |
| DICKER PAIRS (10 pairs) | 186 | 32 |
| DISPLACEMENT TONNAGE | 194 | 37 |
| DOZEN | 7 | 1 |
| DOZEN PAIR | 113 | 32 |
| DRY GRAMS OF LACTIC MATTER | 156 | 524 |
| DRY KILOGRAMS OF LACTIC MATTER | 157 | 524 |
| DRY OUNCES OF LACTIC MATTER | 158 | 524 |
| DRY POUNDS OF LACTIC MATTER | 164 | 524 |
| EACH | 4 | 1 |
| EACH CONTAINER | 44 | 1 |
| EACH PACK | 135 | 2 |
| FEET | 13 | 5 |
| GIGABECQUEREL | 71 | 7 |
| GIGAJOULE | 136 | 8 |
| GIGAWATT HOUR | 163 | 8 |
| GRAM | 1 | 2 |
| GRAM (SEMI-GROSS WEIGHT) | 69 | 25 |
| GRAM NET/EDA | 149 | 9 |
| GRAM OF CHROMIUM (Cr) | 122 | 520 |
| GRAM OF FISSILE ISOTOPE(GFI) | 108 | 508 |
| GRAM OF GOLD (Au) | 115 | 513 |
| GRAM OF IRIDIUM (Ir) | 119 | 517 |
| GRAM OF MANGANESE | 126 | 534 |
| GRAM OF NICKEL (Ni) | 123 | 521 |
| GRAM OF OSMIUM (Os) | 121 | 519 |
| GRAM OF PALLADIUM (Pd) | 117 | 515 |
| GRAM OF PLATINUM (Pt) | 116 | 514 |
| GRAM OF RHODIUM (Rh) | 118 | 516 |
| GRAM OF RUTHENIUM (Ru) | 120 | 518 |
| GRAM OF SILICON (Si) | 127 | 525 |
| GRAM OF SILVER (Ag) | 114 | 512 |
| GRAM OF TUNGSTEN (W) | 124 | 535 |
| GRAM OF VANADIUM (V) | 125 | 523 |
| GRAMS CHOLINE CHLORHYDRATE (C5H14CLNO) | 371 | 529 |
| GRAMS DIPHOSPHORUS PENTAOXIDE (P2O5) | 329 | 510 |
| GRAMS DIPOTASSIUM OXIDE (K2O) | 332 | 511 |
| GRAMS DIPOTASSIUM PENTAOXIDE (K2O5) | 399 | 541 |
| GRAMS METHYLAMINE (CH5N) | 374 | 530 |
| GRAMS NET/MAS | 85 | 9 |
| GRAMS NITROGEN (N) | 326 | 509 |
| GRAMS OF ANHYDIOUS MORPHINE CONTENT | 377 | 531 |
| (C17H19NO3) | | |
| GRAMS OF COPPER CONTENT (Cu) | 393 | 539 |
| GRAMS OF FISSIONABLE MATERIAL | 208 | 500 |
| GRAMS OF HYDROGEN PEROXIDE (H2O2) | 314 | 505 |
| GRAMS OF LEAD CONTENT (Pb) | 390 | 538 |
| GRAMS OF MAGNESIUM (Mg) | 384 | 536 |
| GRAMS OF MOLYBDENUM (Mo) | 387 | 537 |
| GRAMS OF PHOSPHORUS PENTOXIDE (P2O5) | 317 | 506 |
| GRAMS OF POTASIUM HYDROXIDE (KOH) | 305 | 502 |
| GRAMS OF POTASSIUM OXIDE (K2O) | 311 | 504 |
| GRAMS OF SODIUM HYDROXIDE (NaOH) | 308 | 503 |
| GRAMS OF SUCROSE (C12H22O11) | 204 | 522 |
| GRAMS OF TOTAL SOLUBLE SOLIDS | 396 | 540 |
| GRAMS OF URANIUM (U) | 320 | 507 |
| GRAMS OF ZINC (Zn) | 146 | 509 |
| GRAMS PER 1% BY WEIGHT OF SUCROSE | 210 | 543 |
| GRAMS PER THOUSAND UNITS | 78 | 39 |
| GRAMS VOLATILE ORGANIC COMPOUND(VOC) | 402 | 542 |
| GROSS (i.e. 12 DOZENS) | 37 | 1 |
| HECTOGRAM OF GOLD (Au) | 404 | 513 |
| HECTOGRAM OF PLATINUM (Pt) | 403 | 514 |
| HECTOGRAM OF SILVER (Ag) | 405 | 512 |
| HECTOLITER | 15 | 4 |
| HECTOLITER OF PURE ALCOHOL | 155 | 18 |
| HORSE POWER | 141 | 30 |
| IMPERIAL GALLON | 14 | 4 |
| IMERIAL TON | 11 | 2 |
| INCHE | 17 | 5 |
| IU(INSULIN UNIT) | 128 | 526 |
| KILOGRAM (SEMI-GROSS WEIGHT) | 70 | 25 |
| KILOGRAM OF 90% DRY SUBSTANCE | 93 | 14 |
| KILOGRAMS | 5 | 2 |
| KILOGRAMS CHOLINE CHLORHYDRATE | 150 | 529 |
| (C5H14CLNO) | | |
| KILOGRAMS DIPHOSPHORUS PENTAOXIDE (P2O5) | 110 | 510 |
| KILOGRAMS DIPOTASSIUM OXIDE (K2O) | 111 | 511 |
| KILOGRAMS DIPOTASSIUM PENTAOXIDE (K2O5) | 189 | 541 |
| KILOGRAMS DRY AIR | 40 | 13 |
| KILOGRAMS DRY WEIGHT | 101 | 12 |
| KILOGRAMS METHYLAMINE (CH5N) | 151 | 530 |
| KILOGRAMS NET/EDA | 68 | 9 |
| KILOGRAMS NET/MAS | 84 | 9 |
| KILOGRAMS NITROGEN (N) | 109 | 509 |
| KILOGRAMS OF NAMED SUBSTANCE | 41 | 2 |
| KILOGRAMS OF ANHYDIOUS MORPHINE CONTENT | 166 | 531 |
| (C17H19NO3) | | |
| KILOGRAMS OF CHROMIUM (Cr) | 357 | 520 |
| KILOGRAMS OF COPPER CONTENT (Cu) | 175 | 539 |
| KILOGRAMS OF FISSILE ISOTOPE(KFI) | 321 | 508 |
| KILOGRAMS OF FISSIONABLE MATERIAL | 300 | 500 |
| KILOGRAMS OF GOLD (Au) | 336 | 513 |
| KILOGRAMS OF HYDROGEN PEROXIDE (H2O2) | 89 | 505 |
| KILOGRAMS OF IRIDIUM (Ir) | 348 | 517 |
| KILOGRAMS OF LEAD CONTENT (Pb) | 174 | 538 |
| KILOGRAMS OF MAGNESIUM (Mg) | 172 | 536 |
| KILOGRAMS OF MANGANESE (Mn) | 170 | 534 |
| KILOGRAMS OF MOLYBDENUM (Mo) | 173 | 537 |
| KILOGRAMS OF NICKEL (Ni) | 360 | 521 |
| KILOGRAMS OF OSMIUM (Os) | 354 | 519 |
| KILOGRAMS OF PALLADIUM (Pd) | 342 | 515 |
| KILOGRAMS OF PHOSPHORUS PENTOXIDE (P2O5) | 90 | 506 |
| KILOGRAMS OF PLATINUM (Pt) | 339 | 514 |
| KILOGRAMS OF POTASIUM HYDROXIDE (KOH) | 86 | 502 |
| KILOGRAMS OF POTASSIUM OXIDE (K2O) | 88 | 504 |
| KILOGRAMS OF RHODIUM (Rh) | 345 | 516 |
| KILOGRAMS OF RUTHENIUM (Ru) | 351 | 518 |
| KILOGRAMS OF SILICON (Si) | 366 | 525 |
| KILOGRAMS OF SILVER (Ag) | 333 | 512 |
| KILOGRAMS OF SODIUM HYDROXIDE (NaOH) | 87 | 503 |
| KILOGRAMS OF SUCROSE (C12H22O11) | 206 | 522 |
| KILOGRAMS OF TOBACCO CONTENT | 195 | 16 |
| KILOGRAMS OF TOTAL SOLUBLE SOLIDS | 181 | 540 |
| KILOGRAMS OF TUNGSTEN CONTENT (W) | 171 | 535 |
| KILOGRAMS OF URANIUM (U) | 91 | 507 |
| KILOGRAMS OF VANADIUM (V) | 363 | 523 |
| KILOGRAMS OF VOLATILE ORGANIC COMPOUND | 193 | 2 |
| (VOC) | | |
| KILOGRAMS OF ZINC (Zn) | 143 | 509 |
| KILOGRAMS ON DRAINED WEIGHT | 168 | 17 |
| KILOGRAMS PER 1% BY WEIGHT OF SUCROSE | 211 | 543 |
| KILOGRAMS PER THOUSAND UNITS | 79 | 39 |
| KILOGRAMS/BR (Gross) | 26 | 15 |
| KILOGRAMS/TOTAL ALCOHOL | 100 | 11 |
| KILOLITER | 58 | 4 |
| KILOMETER | 6 | 5 |
| KILOWATT | 8 | 30 |
| KILOWATTS/HOUR | 10 | 8 |
| LITER | 3 | 4 |
| LITER OF PURE ALCOHOL | 42 | 18 |
| LITER OF VINEGAR | 191 | 26 |
| MEGABECQUIEREL | 72 | 7 |
| MEGAJOULE | 159 | 8 |
| MEGAWATT HOUR | 142 | 8 |
| METER | 2 | 5 |
| METRIC CARAT (200G) | 9 | 2 |
| METRIC TON | 10 | 2 |
| METRIC TON DRY AIR | 43 | 13 |
| METRIC TON NET | 62 | 9 |
| MILE | 23 | 5 |
| MILLILITER | 24 | 4 |
| MILIMETER | 19 | 5 |
| NA | 999 | 999 |
| NUMBER OF CELLS | 152 | 1 |
| NUMBER OF SEATS | 138 | 46 |
| NUMER OF SET | 45 | 31 |
| NUMER OR UNIT | 18 | 1 |
| OCTANE LEVEL | 65 | 41 |
| ONCE | 12 | 2 |
| ONCE (SEMI-GROSS WEIGHT) | 77 | 25 |
| ONCES OF SUCROSE (C12H22O11) | 207 | 522 |
| ONCES OF ZiNC (Zn) | 147 | 509 |
| ONCES PER 1% BY WEIGHT OF SUCROSE | 213 | 543 |
| OUNCES CHOLINE CHLORHYDRATE (C5H14CLNO) | 370 | 529 |
| OUNCES DIPHOSPHORUS PENTAOXIDE (P2O5) | 328 | 510 |
| OUNCES DIPOTASSIUM OXIDE (K2O) | 331 | 511 |
| OUNCES DIPOTASSIUM PENTAOXIDE (K2O5) | 398 | 541 |
| OUNCES METHYLAMINE (CH5N) | 373 | 530 |
| OUNCES NITROGEN (N) | 325 | 509 |
| OUNCES OF ANHYDIOUS MORPHINE CONTENT | 376 | 531 |
| (C17H19NO3) | | |
| OUNCES OF CHROMIUM (Cr) | 359 | 520 |
| OUNCES OF COPPER CONTENT (Cu) | 392 | 539 |
| OUNCES OF FISSILE ISOTOPE(OFD | 323 | 508 |
| OUNCES OF FISSIONABLE MATERIAL | 302 | 500 |
| OUNCES OF GOLD (Au) | 338 | 513 |
| OUNCES OF HYDROGEN PEROXIDE (H2O2) | 313 | 505 |
| OUNCES OF IRIDIUM (Ir) | 350 | 517 |
| OUNCES OF LEAD CONTENT (Pb) | 389 | 538 |
| OUNCES OF MAGNESIUM (Mg) | 383 | 536 |
| OUNCES OF MANGANESE (Mn) | 379 | 534 |
| OUNCES OF MOLYBDENUM (Mo) | 386 | 537 |
| OUNCES OF NICKEL (Ni) | 362 | 521 |
| OUNCES OF OSMIUM (Os) | 356 | 519 |
| OUNCES OF PALLADIUM (Pd) | 344 | 515 |
| OUNCES OF PHOSPHORUS PENTOXIDE (P2O5) | 316 | 506 |
| OUNCES OF PLATINUM (Pt) | 341 | 514 |
| OUNCES OF POTASIUM HYDROXIDE (KOH) | 304 | 502 |
| OUNCES OF POTASSIUM OXIDE (K2O) | 310 | 504 |
| OUNCES OF RHODIUM (Rh) | 347 | 516 |
| OUNCES OF RUTHENIUM (Ru) | 353 | 518 |
| OUNCES OF SILICON (Si) | 368 | 525 |
| OUNCES OF SILVER (Ag) | 335 | 512 |
| OUNCES OF SODIUM HYDROXIDE (NaOH) | 307 | 503 |
| OUNCES OF TOTAL SOLUBLE SOLIDS | 395 | 540 |
| OUNCES OF TUNGSTEN (W) | 381 | 535 |
| OUNCES OF URANIUM (U) | 319 | 507 |
| OUNCES OF VANADIUM (V) | 365 | 523 |
| OUNCES PER THOUSAND UNITS | 81 | 39 |
| OUNCES VOLATILE ORGANIC COMPOUND(VOC) | 401 | 542 |
| PAIR | 8 | 32 |
| PER ENTRY | 205 | 38 |
| PER LEAF OR TUBE | 137 | 1 |
| PERCENTAGE OF ALCOHOL | 188 | 20 |
| PERCENTAGE OF SULPHUR | 96 | 42 |
| PINT | 27 | 4 |
| POUND | 9 | 2 |
| POUND (SEMI-GROSS WEIGHT) | 76 | 25 |
| POUNDS CHOLINE CHLORHYDRATE (C5H14CLNO) | 369 | 529 |
| POUNDS DIPHOSPHORUS PENTAOXIDE (P2O5) | 327 | 510 |
| POUNDS DIPOTASSIUM OXIDE (K2O) | 330 | 511 |
| POUNDS DIPOTASSIUM PENTAOXIDE (K2O5) | 397 | 541 |
| POUNDS METHYLAMINE (CH5N) | 372 | 530 |
| POUNDS NITROGEN (N) | 324 | 509 |
| POUNDS OF ANHYDIOUS MORPHINE CONTENT | 375 | 531 |
| (C17H19NO3) | | |
| POUNDS OF CHROMIUM (Cr) | 358 | 520 |
| POUNDS OF COPPER CONTENT (Cu) | 391 | 539 |
| POUNDS OF FISSILE ISOTOPE(PFI) | 322 | 508 |
| POUNDS OF FISSIONABLE MATERIAL | 301 | 500 |
| POUNDS OF GOLD (Au) | 337 | 513 |
| POUNDS OF HYDROGEN PEROXIDE (H2O2) | 312 | 505 |
| POUNDS OF IRIDIUM (Ir) | 349 | 517 |
| POUNDS OF LEAD CONTENT (Pb) | 388 | 538 |
| POUNDS OF MAGNESIUM (Mg) | 382 | 536 |
| POUNDS OF MANGANESE (Mn) | 378 | 534 |
| POUNDS OF MOLYBDENUM (Mo) | 385 | 537 |
| POUNDS OF NICKEL (Ni) | 361 | 521 |
| POUNDS OF OSMIUM (Os) | 355 | 519 |
| POUNDS OF PALLADIUM (Pd) | 343 | 515 |
| POUNDS OF PHOSPHORUS PENTOXDE (P2O5) | 315 | 506 |
| POUNDS OF PLATINUM (Pt) | 340 | 514 |
| POUNDS OF POTASIUM HYDROXIDE (KOH) | 303 | 502 |
| POUNDS OF POTASSIUM OXIDE (K2O) | 309 | 504 |
| POUNDS OF RHODIUM (Rh) | 346 | 516 |
| POUNDS OF RUTHENIUM (Ru) | 352 | 518 |
| POUNDS OF SILICON (Si) | 367 | 525 |
| POUNDS OF SILVER (Ag) | 334 | 512 |
| POUNDS OF SODIUM HYDROXIDE (NaOH) | 306 | 503 |
| POUNDS OF SUCROSE (C12H22O11) | 209 | 522 |
| POUNDS OF TOTAL SOLUBLE SOLIDS | 394 | 540 |
| POUNDS OF TUNGSTEN (W) | 380 | 535 |
| POUNDS OF URANIUM (U) | 318 | 507 |
| POUNDS OF VANADIUM (V) | 364 | 523 |
| POUNDS OF ZINC (Zn) | 153 | 509 |
| POUNDS PER 1% BY WEIGHT OF SUCROSE | 214 | 543 |
| POUNDS PER THOUSAND UNITS | 82 | 39 |
| POUNDS VOLATILE ORGANIC COMPOUND(VOC) | 400 | 542 |
| POUNDS/BR (Gross) | 38 | 15 |
| PROOF GALLON (US) | 57 | 19 |
| PROOF LITER | 53 | 19 |
| ROLL | 55 | 1 |
| SCORE (i.e. 20 units) | 52 | 1 |
| SQUARE CENTIMETER | 35 | 6 |
| SQUARE FEET | 34 | 6 |
| SQUARE METER | 32 | 6 |
| SQUARE YARD | 162 | 6 |
| STICKS OF TOBACCO | 63 | 27 |
| TETRAJOULE | 61 | 8 |
| TON/BR (Gross) | 140 | 15 |
| TON OF 90% DRY SUBSTANCE (SDT) | 132 | 14 |
| TON/10 | 178 | 2 |
| US GALLON | 16 | 4 |
| VALUE OF METAL CONTENT | 176 | 33 |
| VEHICLE | 47 | 1 |
| YARD | 22 | 5 |

APPENDIX D - Unit Type
Following is a list of unit types:

| Unit | | |
|---|---|---|
| Type | Unit Name | Unit Base |
| 1 | UNIT | each |
| 2 | WEIGHT/NET WEIGHT | grams |
| 3 | VOLUME | cubic meter |
| 4 | CAPACITY | litre |
| 5 | DISTANCE | meter |
| 6 | AREA | squaremeter |
| 7 | RADIATION | becquerel |
| 8 | CONSUMPTION RATE/ENERGY | kw/h |
| 9 | NET/EDA, NET/MAS (NET WEIGHT DRAINED | grams |
| | AND DRYED) | |
| 10 | SACCHARINE NET WEIGHT | grams |
| 11 | TOTAL ALCOHOL IN WEIGHT | grams |
| 12 | DRY WEIGHT | grams |
| 13 | DRY AIR WEIGHT | grams |
| 14 | 90% DRY SUBSTANCE BY WEIGHT (SDT) | grams |
| 15 | GROSS WEIGHT | grams |
| 16 | NET TOBACCO CONTENT | grams |
| 17 | DRAINED WEIGHT | grams |
| 18 | PURE ALCOHOL VOLUME | litre |
| 19 | PROOF VOLUME | litre |
| 20 | PERCENTAGE OF ALCOHOL | each |
| 21 | ENGINE DISPLACEMENT | cubic meter |
| 22 | VOLUME/DAY | cubic meter |
| 23 | DEGREE PLATO | litre |
| 24 | PACK | each |
| 25 | SEMI GROSS WEIGHT | grams |
| 26 | VINEGAR VOLUME | litre |
| 27 | TOBACCO PRODUCTS AND PREPARATION | each |
| 28 | CONTAINER | each |
| 29 | BDU (BONE DRY UNIT) WEIGHT | grams |
| 30 | POWER | kw |
| 31 | SET | each |
| 32 | PAIRS | each |
| 33 | VALUE OF METAL | metal |
| 34 | BOX | each |
| 35 | SHIP HULL CAPACITY | tons |
| 36 | PETROLEUM PRODUCTS | litre |
| 37 | NAVAL DISPLACEMENT MEASURE | tons |
| 38 | PER ENTRY | entry |
| 39 | WEIGHT PER THOUSAND UNITS | grams |
| 40 | % vol per volume | litre |
| 41 | OCTANE LEVEL | octane |
| 42 | PERCENTAGE OF SULPHUR | each |
| 43 | CIGARETTES, CIGARS, CIGARILLOS LENGHT | meter |
| 44 | ELECTRICALY POWERED VEHICLES | cc |
| 45 | HEATING CAPACITY | calorie |
| 46 | NUMBER OF SEATS | seat |
| 501 | NITROGEN (N) WEIGHT | grams |
| 502 | POTASIUM HYDROXIDE (KOH) WEIGHT | grams |
| 503 | SODIUM HYDROXIDE (NaOH) WEIGHT | grams |
| 504 | POTASSIUM OXIDE (K2O) WEIGHT | grams |
| 505 | HYDROGEN PEROXIDE (H2O2) WEIGHT | grams |
| 506 | PHOSPHORUS PENTOXIDE (P2O5) WEIGHT | grams |
| 507 | URANIUM (U) WEIGHT | grams |
| 508 | FISSILE ISOTOPE (GFI) WEIGHT | grams |
| 509 | ZINC (Zn) WEIGHT | grams |
| 510 | DIPHOSPHORUS PENTAOXIDE (P2O5) | grams |
| | WEIGHT | |
| 511 | DIPOTASSIUM OXIDE (K2O) WEIGHT | grams |
| 512 | SILVER (Ag) WEIGHT | grams |
| 513 | GOLD (Au) WEIGHT | grams |
| 514 | PLATINUM (Pt) WEIGHT | grams |
| 515 | PALLADIUM (PD) WEIGHT | grams |
| 516 | RHODIUM (Rh) WEIGHT | grams |
| 517 | IRIDIUM (Ir) WEIGHT | grams |
| 518 | RUTHENIUM (Ru) WEIGHT | grams |
| 519 | OSMIUM (Os) WEIGHT | grams |
| 520 | CHROMIUM (Cr) WEIGHT | grams |
| 521 | NICKEL (Ni) WEIGHT | grams |
| 522 | SUCROSE (C12H22O11) WEIGHT | grams |
| 523 | VANADIUM (V) WEIGHT | grams |
| 524 | LACTIC MATTER DRY WEIGHT | grams |
| 525 | SILICON (Si) WEIGHT | grams |
| 526 | IU (INSULIN UNIT) | unit |
| 527 | PHOSPONIC ANHYDRIDE WEIGHT (P2O5) | grams |
| 529 | CHOLINE CHLORYDRATE (C5H14CLNO) | grams |
| | WEIGHT | |
| 530 | METHYLAMINE (CH5N) WEIGHT | grams |
| 531 | ANHYDROUS MORPHINE (C17H19NO3) | grams |
| | CONTENT WEIGHT | |
| 534 | MANGANESE (Mn) WEIGHT | grams |
| 535 | TUNGSTEN (W) CONTENT WEIGHT | grams |
| 536 | MAGNESIUM (Mg) WEIGHT | grams |
| 537 | MOLYBDENUM (Mo) WEIGHT | grams |
| 538 | LEAD CONTENT (Pb) WEIGHT | grams |
| 539 | COPPER (Cu) CONTENT WEIGHT | grams |
| 540 | TOTAL SOLUBLE SOLIDS WEIGHT | grams |
| 541 | DIPOTASSIUM PENTAOXIDE (K2O5) WEIGHT | grams |
| 542 | VOLATILE ORGANIC COMPOUND | grams |
| | (VOC) WEIGHT | |
| 543 | 1% BY WEIGHT OF SUCROSE | grams |
| 999 | NA | 999 |

APPENDIX E - Output Format Codes
Following are output format codes:

| Output Format | Code |
|---|---|
| Duty Rates | 1 |
| Duty Amounts | 2 |
| Detailed Duty | 3 |
| Tax Rates | 4 |
| Tax Amounts | 5 |
| Detailed Taxes | 6 |
| Duty and Tax Rates | 7 |
| Duty and Tax Amounts | 8 |
| Detailed Duty and Taxes | 9 |
| Landed Cost | 10 |

APPENDIX F - Access Codes
Following are output format codes:

| Access Codes | Code |
|---|---|
| Within access | 1 |
| Over access | 2 |

APPENDIX G - Input Code Types
Following are input format codes:

| Access Codes | Code |
|---|---|
| Product Code | 1 |
| Tariffeed Internal Use | 2 |
| HS Code | 3 |

APPENDIX H - Requested Values and Data Validation (Input)

| Input | Type | Valid Values | Example |
|---|---|---|---|
| Pin Number | String | 1 character followed | “a-11111111” |
| | | by a dash and 8 | |
| | | numbers | |
| Access Code | String | Number from 0 to 2 | “1” |
| | | see “Appendix F” | |
| Origin Country | String | 2 characters | “us” |
| | | see “Appendix A” | |
| Shipment Country | String | 2 characters | “us” |
| | | see “Appendix A” | |
| Destination Country | String | 2 characters | “ca” |
| | | see “Appendix A” | |
| Input Code Type | String | Number from 1 to 3 | “1” |
| | | see “Appendix G” | |
| Product Code | String | String value of the | “4901990091” |
| | | product code | |
| | | (alphanumeric) | |
| Transaction Value | String | Number from | “500000” |
| | | 0 to 1.7 × 10³⁰⁸ | |
| Number of Unit | String | Number from | “5” |
| | | 0 to 1.7 × 10³⁰⁸ | |
| Unit Code | String | Number from 0 to | “4” |
| | | 999 | |
| | | See “Appendix C” | |
| Cost of Transport | String | Number from | “500” |
| | | 0 to 1.7 × 10³⁰⁸ | |
| Insurance Cost | String | Number from | “250” |
| | | 0 to 1.7 × 10³⁰⁸ | |
| Other Costs | String | Number from | “25” |
| | | 0 to 1.7 × 10³⁰⁸ | |
| Transaction Currency | String | 3 characters | “cad” |
| | | see Appendix B | |
| Conversion Currency | String | 3 characters | “cad” |
| | | see “Appendix B” | |
| Output Format | String | Number from 1 to 10 | “10” |
| | | See “Appendix E” | |

APPENDIX I - Returned Values (Output)

| 1-Duty Rate | 2-Duty Amount | 3-Detailed Duty |
|---|---|---|
| Customs Tariff Rates* | Duty Amount | Customs Tariff Rates* |
| Per Unit Customs Tariff | | Per Unit Customs Tariff |
| Product Base Unit | | Product Base Unit |
| | | Duty Amount |
| 4-Tax Rates | 5-Tax Amounts | 6-Detailed Taxes |
| t | | |
| Tax Name | Sum Taxes | Sum Taxes |
| Category | | |
| Tax Rate | Category | Tax Rate |
| Per Unit Tax | Tax Amount | Per Unit Tax |
| Tax Base Unit | | Tax Base Unit |
| | Category | Tax Amount |
| Tax Name | Tax Amount | Category |
| Category | | |
| Tax Rate | (. . .) | Tax Rate |
| Per Unit Tax | | Per Unit Tax |
| Tax Base Unit | | Tax Base Unit |
| | | Tax Amount |
| (. . .) | | Category |
| | | (. . .) |
| | 8-Duty and | |
| 7-Duty and Tax Rates | Tax Amounts | 9-Detailed Duty and Taxes |
| Customs Tariff Rates* | Duty | |
| Per Unit Customs Tariff | Sum Taxes | |
| Product Base Unit | | Duty |
| | Category | Customs Tariff Rate |
| | Tax Amount | Per Unit Customs Tariff |
| | | Product Base Unit |
| Tax Name | Category | Sum Taxes |
| Category | Tax Amount | |
| Tax Rate | | Tax Rate |
| Per Unit Tax | (. . .) | Per Unit Tax |
| Tax Base Unit | | Tax Base Unit |
| | | Tax Amount |
| Tax Name | | Category |
| Category | | Tax Name |
| Tax Rate | | |
| Per Unit Tax | | Tax Rate |
| Tax Base Unit | | Per Unit Tax |
| | | Tax Base Unit |
| (. . .) | | Tax Amount |
| | | Category |
| | | Tax Name |
| | | (. . .) |
| 10-Landed Cost | | |
| Value | | |
| Cost of Transportation | | |
| Insurance Cost | | |
| Other Cost | | |
| Duty | | |
| Sum Taxes | | |
| Total Landed Cost | | |
| Category | | |
| Tax Amount | | |
| Category | | |
| Tax Amount | | |
| (. . .) | | |

*If Customs Tariff Rate is equal to 999999, the product is prohibited in the specified country.

What is claimed is:

1. A real-time global tariff and import data system comprising:
A. a data storage system, comprising a set of tariff and duty data including, for each of a plurality of countries, a set of product codes and corresponding duty rates and import tax rates;
B. an input mechanism, configured to accept a set of transaction information including origin country, shipment country, destination country, subject product code, transaction value, quantity of product units, and transaction currency;
C. a duty calculation engine, configured to calculate a subject product duty as a function of said duty rate and said set of transaction information; and
D. a tax calculation engine, configured to calculate a subject product import tax as a function of said tax rate and said set of transaction information.

2. A system as in claim 1, wherein said data storage system is coupled to a remote data source configured to supply at least a subset of said set of tariff and duty data.

3. A system as in claim 1, wherein said data storage system is coupled to a remote data source configured to update said set of tariff and duty data.

4. A system as in claim 1, further comprising:
E. a Web server system, coupled to said duty calculation engine and said tax calculation engine, wherein said Web server system includes a Web page generator configured to generate said input mechanism as a set of Web pages.

5. A system as in claim 4, wherein said Web server system is accessible via one or more wired or wireless networks from a group of networks comprising:
1) the Internet;
2) the Web;
3) a virtual private network;
4) an extranet;
5) an intranet;
6) a telephone network; and
7) a satellite network.

6. A system as in claim 1, wherein said tariff and import data system includes or is configured to access international transaction restriction information, said system further comprising:
E. a transaction validater, configured to verify that said set of transaction inputs complies with relevant said international transaction restriction information.

7. A real-time global tariff and import data system comprising:
A. a data storage system, comprising a set of tariff and duty data including, for each of a plurality of countries, a set of product codes and corresponding duty rates and import tax rates;
B. an input mechanism, configured to accept a set of transaction information including origin country, shipment country, destination country, subject product code, transaction value, quantity of product units, and transaction currency;
C. a duty calculation engine, configured to calculate a subject product duty as a function of said duty rate and said set of transaction information; and
D. a tax calculation engine, configured to calculate a subject product import tax as a function of said tax rate and said set of transaction information; and
E. a total landed cost engine, configured to calculate a total landed cost from said subject product duty, said subject product import tax, and a set of ancillary cost information.

8. A system as in claim 7, wherein said ancillary cost information includes costs from a group comprising:
1) insurance costs; and
2) transportation costs.

9. A system as in claim 7, wherein said real-time global tariff and import data system is coupled to a transportation system configured to generate a transportation cost associated with said set of transaction inputs, wherein said transportation cost comprises at least a portion of said ancillary cost information.

10. A system as in claim 9 wherein said real-time global tariff and import data system is enabled to procure transportation services via said transportation system.

11. A system as in claim 7, wherein said real-time global tariff and import data system is coupled to an insurance system configured to generate an insurance cost associated with said set of transaction inputs, wherein said insurance cost comprises at least a portion of said ancillary cost information.

12. A system as in claim 11 wherein said real-time global tariff and import data system is enabled to procure insurance coverage via said insurance system.

13. A real-time global tariff and import data system comprising:
A. a data storage system, comprising a set of tariff and duty data including, for each of a plurality of countries, a set of product codes and corresponding duty rates and import tax rates;
B. an input mechanism, configured to accept a set of transaction information including output format code, origin country, shipment country, destination country, subject product code, transaction value, quantity of product units, and transaction currency;
C. a duty calculation engine, configured to calculate a subject product duty as a function of said duty rate and said set of transaction information; and
D. a tax calculation engine, configured to calculate a subject product import tax as a function of said tax rate and said set of transaction information; and
E. an output mechanism, configured to selectively invoke said duty calculation engine and said import tax calculation engine as a function of said output format code,
wherein said system includes a set of predetermined output formats with each output format having a unique output format code, and wherein each of said output formats includes at least one of subject product duty information or subject product tax information.

14. A system as in claim 13, wherein said at least one of subject product duty information or subject product tax information include information chosen from a group comprising:
1) duty rate;
2) duty amount;
3) tax rate;
4) duty amount;
5) detailed duty; and
6) detailed tax.

15. A real-time global tariff and import data system comprising:
A. a data storage system, comprising a set of tariff and duty data including, for each of a plurality of countries, a set of product codes and corresponding duty rates and import tax rates;
B. an input mechanism, configured to accept a set of transaction information including output format code, origin country, shipment country, destination country, subject product code, transaction value, quantity of product units, transaction currency, and ancillary cost information;
C. a duty calculation engine, configured to calculate a subject product duty as a function of said duty rate and said set of transaction information; and
D. a tax calculation engine, configured to calculate a subject product import tax as a function of said tax rate and said set of transaction information; and
E. a total landed cost engine, configured to calculate a total landed cost from said duty, said import tax, and ancillary cost information; and
F. an output mechanism, configured to selectively invoke said duty calculation engine and said import tax calculation engine as a function of said output format code,
wherein said system includes a set of predetermined output formats with each output format having a unique output format code, and wherein each of said output formats includes at least one of duty or tax rate or amount information.

16. A system as in claim 15, wherein said input mechanism is configured to accept XML requests comprising said set of transaction information.

17. A real-time global tariff system, accessible via a network, comprising:
A. a data storage system comprising duty data including, for each of a plurality of countries, a set of product codes and corresponding duty rates;
B. an input mechanism, configured to accept a set of transaction information including origin country, shipment country, destination country, subject product code, transaction value, quantity of product units, transaction currency, and ancillary cost information;
C. a duty calculation engine, configured to calculate a subject product duty as a function of said duty rate and said set of transaction information;
D. a Web server system, coupled to said duty calculation engine, wherein said Web server system includes a Web page generator configured to generate said input mechanism as a set of Web pages; and
E. an output mechanism, configured to selectively invoke said duty calculation engine and wherein said Web server system is configured to generate a Web page presenting said duty.

18. A real-time global import tax system, accessible via a network, comprising:
A. a data storage system comprising import tax data including, for each of a plurality of countries, a set of product codes and corresponding import tax rates;
B. an input mechanism, configured to accept a set of transaction information including origin country, shipment country, destination country, product code, transaction value, quantity of product units, transaction currency, and ancillary cost information;
C. a tax calculation engine, configured to calculate a subject product import tax as a function of said tax rate and said set of transaction information;
D. a Web server system, coupled to said tax calculation engine, wherein said Web server system includes a Web page generator configured to generate said input mechanism as a set of Web pages; and
E. an output mechanism, configured to selectively invoke said tax calculation engine and wherein said Web server system is configured to generate a Web page presenting said tax.

19. A method of providing real-time global tariff and import data over a networked computer system, said method comprising:
A. establishing in a data storage system a set of tariff data and duty data, including for each of a plurality of countries, a set of product codes and corresponding duty rates and import tax rates;
B. entering at a client device a set of transaction inputs including origin country, shipment country, destination country, subject product code, transaction value, quantity of product units, and transaction currency;
C. transmitting said set of transaction information to a tariff and import data system;
D. calculating a subject duty, as a function of a product duty rate and said set of transaction information;
E. calculating a subject import tax, as a function of a product duty rate and said set of transaction information; and
F. transmitting said subject duty and said subject import tax to said client device in substantially real-time.

20. A method as in claim 19, wherein said client device and tariff and import data system are remote to each other and parts C and F include transmitting over one or more wired or wireless networks from a group of networks comprising:
1) the Internet;
2) the Web;
3) a virtual private network;
4) an extranet;
5) an intranet;
6) a telephone network; and
7) a satellite network.

21. A method as in claim 19, wherein said tariff and import data system includes a Web server system, said method further comprising in part B:
B.1 generating a set of Web pages for accepting said set of transaction information; and
B.2 validating said set of transaction information against predetermined syntax and semantic constraints.

22. A method as in claim 19, wherein a plurality of output formats are stored in said tariff and import data system and each output format has a corresponding output format code,
wherein part P includes:
B.1 entering a subject output format code; and
wherein said method further comprises:
G. outputting one or more of said subject duty, and said subject import tax at said client device in an output format corresponding to said subject output code.

23. A method of providing real-time global tariff and import data over a networked computer system, said method comprising:
A. establishing in a data storage system a set of tariff data and duty data, including for each of a plurality of countries, a set of product codes and corresponding duty rates and import tax rates;
B. entering at a client device a set of transaction inputs including origin country, shipment country, destination country, subject product code, transaction value, quantity of product units, and transaction currency;
C. transmitting said set of transaction information to a tariff and import data system;
D. calculating a subject duty, as a function of a product duty rate and said set of transaction information;
E. calculating a subject import tax, as a function of a product duty rate and said set of transaction information; and
F. calculating a total landed cost as a function of said subject product duty, said subject product import tax, and a set of ancillary information; and
G. transmitting one or more of said subject duty, said subject import tax, and said total landed cost to said client device in substantially real-time.

24. A method as in claim 23, wherein said ancillary cost information includes costs from a group comprising:
1) insurance costs; and
2) transportation costs.

25. A method as in claim 24, wherein said tariff and import data system is coupled to a transportation system and part F comprises:
F.1 generating a transportation cost associated with said set of transaction inputs, wherein said transportation cost comprises at least a portion of said ancillary cost information.

26. A method as in claim 25, wherein part F further comprises:
F.2 procuring transportation via said transportation system.

27. A method as in claim 24, wherein said tariff and import data system is coupled to an insurance system and part F comprises:
F.1 generating an insurance cost associated with said set of transaction inputs, wherein said insurance cost comprises at least a portion of said ancillary cost information.

28. A method as in claim 27, wherein part F further comprises:
F.2 procuring insurance via said insurance system.

29. A method as in claim 24, wherein a plurality of output formats are stored in said tariff and import data system and each output format has a corresponding output format code, wherein part P includes:
B.1 entering a subject output format code; and
wherein said method further comprises:
H. outputting one or more of said subject duty, said subject import tax, and said total landed cost at said client device in an output format corresponding to said subject output code.

30. A method of providing real-time global tariff data over a networked computer system, said method comprising:
A. establishing in a data storage system a set of duty data, including for each of a plurality of countries, a set of product codes and corresponding duty rates and a plurality of output formats wherein each output format has a corresponding output format code;
B. entering at a client device a set of transaction inputs including origin country, shipment country, destination country, subject product code, transaction value, quantity of product units, transaction currency and subject product code;
C. transmitting said set of transaction information to a tariff and import data system;
D. calculating a subject duty, as a function of a product duty rate and said set of transaction information;
E. transmitting said subject duty to said client device in substantially real-time; and
G. outputting said subject duty at said client device in an output format corresponding to said subject output code.

31. A method of providing real-time global import tax data over a networked computer system, said method comprising:
A. establishing in a data storage system a set of import tax data, including for each of a plurality of countries, a set of product codes and corresponding import tax rates and a plurality of output formats wherein each output format has a corresponding output format code;
B. entering at a client device a set of transaction inputs including origin country, shipment country, destination country, subject product code, transaction value, quantity of product units, transaction currency and subject product code;
C. transmitting said set of transaction information to a tariff and import data system;
D. calculating a subject import tax, as a function of a product import tax rate and said set of transaction information;
E. transmitting said subject import tax to said client device in substantially real-time; and
G. outputting said subject import tax at said client device in an output format corresponding to said subject output code.
